(19) United States
(12) Patent Application Publication
(10) Pub. No.: US 2003/0137697 A1
(43) Pub. Date: Jul. 24, 2003

(54) Image signal processing apparatus

(75) Inventors: Shinichi Sato, Yokohama-shi (JP); Yoshikazu Y Naito, Yokohama-shi (JP); Toshiaki Watanabe, Yokohama-shi (JP)

Correspondence Address: GREENBLUM & BERNSTEIN, P.L.C., 1950 ROLAND CLARKE PLACE, RESTON, VA, 20191, US

(73) Assignee: MATSUSHITA GRAPHIC COMMUNICATION SYSTEMS, INC., Tokyo (JP)

(21) Appl. No.: 10/347,287

(22) Filed: Jan. 21, 2003

(30) Foreign Application Priority Data
Jan. 21, 2002 (JP) JP 2002-011527

(51) Int. Cl. H04N 1/405; H04N 1/409; H04N 1/40; G06T 5/00

(52) U.S. Cl. 358/2.1; 358/3.06; 358/1.2; 358/3.27

(57) ABSTRACT

The present invention adopts a configuration making a decision on a half-tone dot image focused on cyclicity of an image of a half-tone dot decision information adding circuit 102 on an image input from an image reader 101 in advance, adding the decision result to the image as half-tone dot decision information and carrying out various kinds of image processing using the image data in an arbitrary order. Image processing blocks 103, 104 and 105 store added half-tone dot decision information and transmit the half-tone dot decision information to the next block. The scaling circuit 104 is constructed in such a way as to decide, in the case of scale-up, half-tone dot decision information scaled up based on the output pixel position and half-tone dot decision information before and after the pixel position and decide, in the case of scale-down, half-tone dot decision information scaled down by decision by majority or under an OR condition of the half-tone dot decision information within the input pixel range corresponding to one pixel output.

### BACKGROUND OF THE INVENTION

1. Field of the Invention

The present invention relates to an image signal processing apparatus that carries out image zoning on an input image.

2. Description of the Related Art

An image zoning processing circuit which decides whether a continuous-tone image input is a character image, photo image or half-tone dot image (image zoning) and carries out image processing best-suited to each image zone is known.

A conventional image zoning processing circuit carries out scaling processing on an input image through its scaling section first and then inputs the image to the image zoning processing circuit. The image zoning processing circuit is constructed of a character/photo/half-tone dot correspondence processing section and a character/photo/half-tone dot decision circuit. The character/photo/half-tone dot decision circuit gives the decision result to the character/photo/half-tone dot correspondence processing section and the character/photo/half-tone dot handling/processing section carries out processing corresponding to each image zone of character, photo or half-tone dot based on the decision result.

Furthermore, another image zoning processing circuit provides an edge enhancement section before the image zoning processing circuit so that the input image is subjected to edge enhancement processing by the edge enhancement section and then input to the character/photo/half-tone dot decision circuit and the character/photo/half-tone dot correspondence processing section.

However, when scaling processing or edge enhancement processing is carried out before image zoning processing, problems such as deterioration of the accuracy of image zoning decision, especially determination of the accuracy of detection of half-tone dot images, occur making it impossible to carry out normal image zoning processing.

A method commonly used for deciding half-tone dot images is one that decides half-tone dots focusing on the cyclicity of an image, but this method has difficulty in correctly deciding an image whose cyclic structure has been altered due to scaling processing.

One possible measure for this problem is to switch image zoning parameter values for several fixed scaling ratios.

However, it is extremely difficult for the method of switching image zoning parameter values for several fixed scaling ratios to support arbitrary scaling ratio settings in a main or sub scanning direction or support arbitrary image processing order such as edge enhancement or gamma correction.

### SUMMARY OF THE INVENTION

It is an object of the present invention to provide an image signal processing apparatus capable of carrying out scaling processing with an arbitrary scaling ratio prior to image zoning processing.

It is another object of the present invention to provide an image signal processing apparatus capable of making an arbitrary image processing order setting such as scaling processing, edge enhancement or gamma correction prior to the image zoning processing.

The present invention is constructed in such a way that a half-tone dot image decision is performed on an input image from a document reader focusing on the cyclicity of the image in advance, the decision result is added to the image as half-tone dot decision information and various types of image processing are executed using the image data in an arbitrary order. Furthermore, each image processing block stores the added half-tone dot decision information and transmits it to the next block.

This allows a half-tone dot decision to be made at a time point at which the image is input, and therefore even if the cycle or signal amplitude of the half-tone dot image is changed by image processing at some midpoint, it is possible to realize image zoning processing on characters, photo or half-tone dot image after various kinds of image processing without being affected by the change. Moreover, even if the image processing order is changed arbitrarily for the same reason, the image zoning processing after the image processing can also be realized.

The scaling correction processing of the present invention decides, for scaling up, scaled-up half-tone dot decision information based on the relationship between the position of an output pixel and half-tone dot decision information on the pixel positions before and after that pixel position and decides, for scaling down, scaled-down half-tone dot decision information based on decision by majority of half-tone dot decision information within the range of the input pixel corresponding to one pixel output or under an OR condition.

This makes it possible to transmit the half-tone dot decision information to the next block also when scaling processing is applied.

The present invention is constructed in such a way that multi-value data is divided into blocks, information indicating whether each block is a half-tone dot or non-half-tone dot is added to fixed-length coding data obtained through orthogonal conversion and quantization processing and image data including the half-tone dot decision information can thereby be compressed.

This allows a half-tone dot image to exist as a cluster having a predetermined area or greater and even if the resolution of the half-tone dot decision information is down-sampled to about the size of the coding block (8×8 pixels), this prevents the down-sampling from affecting the image quality in the subsequent image zoning processing, making it possible to decide whether the block is a half-tone dot or non-half-tone dot by the number of half-tone dot decision pixels input into the block, convert it to 1-bit information, and transmit the half-tone dot decision information to the next block even if the image data is subjected to compression/reconstruction processing. Furthermore, depending on the result of a decision on whether the block is a half-tone dot or non-half-tone dot, it is possible to switch between multi-value data quantization tables, cut a high frequency base component which may cause moiré through the half-tone dot decision section, use extra bits for the low frequency basic bits and thereby reduce moiré of the reconstructed half-tone dot image section.

A first aspect of the present invention is an image signal processing apparatus comprising a data input section that inputs image data, a half-tone dot decision information adding section that sequentially references a predetermined reference range of the image data input by the data input section, decides whether the image data is a half-tone dot image or not, adds the half-tone dot decision result data to the image data located in the center of the reference range and outputs the image data and half-tone dot decision result data synchronously, a scaling processing section that receives the image data and half-tone dot decision result data sequentially output from the half-tone dot decision information adding section, performs scaling on the image data and half-tone dot decision result data and outputs the scaled image data and half-tone dot decision result data synchronously and an output section that outputs the image data sequentially output from the scaling processing circuit and half-tone dot decision result data to the outside.

Adopting such a configuration makes it possible to sequentially reference a predetermined reference range of the image data to decide before scaling the input image data whether it is a half-tone dot image or not and allow the scaling processing section to perform scaling processing on the image data and half-tone dot decision result data and output the data to the outside, and thereby transmit the half-tone dot decision result data to the image zoning circuit which follows the scaling processing section.

A second aspect of the present invention is the image signal processing apparatus according to the first aspect, wherein the scaling processing section comprises a sub-scanning scale-down interpolation circuit that carries out interpolation processing on the image data scaled down in the sub-scanning direction, a main scanning scale-down interpolation circuit that carries out interpolation on the image data scaled down in the main scanning direction, a main scanning scale-up interpolation circuit that carries out interpolation processing on the image data scaled up in the main scanning direction, a first and second line memories into which the output data of the input image data, the sub-scanning scale-down interpolation circuit and the main scanning scale-down interpolation circuit are written and a control section that decides whether image data output on the current line is enabled or disabled for each image data input line based on the sub-scanning scale-down ratio, whether the image data output on the next line is enabled or disabled, decides the interpolation circuits to be enabled and the order of processes according to the respective states obtained and controls the data path of the input image data, and the pair of the image data and half-tone dot decision result data is configured to pass through the same data path decided by the control section.

Even if a data path is switched based on the sub-scanning scale-down ratio, this allows a pair of the image data and half-tone dot decision result data to be processed, making it possible to transmit the pair of the image data and half-tone dot decision result data to subsequent image processing blocks.

A third aspect of the present invention is the image signal processing apparatus according to the second aspect, wherein the sub-scanning scale-down interpolation circuit and the main scanning scale-down interpolation circuit perform OR processing on the half-tone dot decision data within the same range as the interpolation range of the image data and generate the processing result as scaled-down half-tone dot decision data.

The half-tone dot decision data is a signal representing the result of deciding for each pixel whether an image is shaded or not. Ideally, there would be no problem if all pixels of a shaded image can be subjected to a half-tone dot decision, but erroneous decisions may be made on various parts of the half-tone dot image due to differences in the cycle or angle of the shading. During scale down, a plurality of pixels overlaps over one pixel to be output, and if a half-tone dot decision matches at least one part of one pixel to be output at that time, there is an effect of reducing areas of erroneous decisions by applying a half-tone dot decision through OR processing.

A fourth aspect of the present invention is the image signal processing apparatus according to the second aspect, wherein the sub-scanning scale-down interpolation circuit and the main scanning scale-down interpolation circuit perform OR processing on the half-tone dot decision data limited to two pixels at predetermined positions within the same range as the interpolation range of the image data and generate the processing result as scaled-down half-tone dot decision data.

In this case, the effect of the OR processing is the same as that described above, but as the scale-down ratio decreases, many input pixels correspond to one pixel to be output and simple OR would make a half-tone dot decision even on characters which exist in the periphery of a half-tone dot image, adversely affecting the character image of the peripheral section. Thus, limiting the range of the OR processing to only two pixels makes it possible to prevent the half-tone dot decision from expanding to the periphery of the half-tone dot image.

A fifth aspect of the present invention is the image signal processing apparatus according to the second aspect, wherein the sub-scanning scale-down interpolation circuit and the main scanning scale-down interpolation circuit count the half-tone dot decision data count within the same range as the interpolation range of image data and generate half-tone dot decision data scaled down according to the count value.

This makes the half-tone dot decision data scaled down based on a decision by majority condition of the half-tone dot decision information within the input pixel range corresponding to one pixel and allows the half-tone dot decision data to be transmitted in pair with the scale-down pixel data.

A sixth aspect of the present invention is the image signal processing apparatus according to the first aspect comprising a scaling control section that calculates positions of output pixels with reference to the position of an input pixel all the time, wherein the sub-scanning scale-down interpolation circuit, the main scanning scale-down interpolation circuit and the main scanning scale-up interpolation circuit select, based on information of the calculated output pixel position and half-tone dot decision data at the same position as that of the input pixel data at two points sandwiching the output pixel position, one of the two half-tone dot decision data pieces according to the size of the information of the calculated output pixel position.

Thus, when linear interpolation is selected for scaling image processing, using a linear interpolation coefficient for also the half-tone dot decision data makes it possible to match the position of the image data to be interpolated and output and the position of the half-tone dot decision data all the time and when an image whose half-tone dot image is close to characters is scaled up or slightly scaled down, there will be no discrepancy between the image and half-tone dot decision result, thus having the effect of securing the image quality.

However, OR processing is more effective when the scale-down ratio is decreased (e.g., 50% or less).

A seventh aspect of the present invention is the image signal processing apparatus according to the first aspect, wherein interpolation processing on half-tone dot decision data is selected according to a selection of scaling interpolation processing of the image data.

This allows interpolation processing on half-tone dot decision data to be selected according to the selection of scaling interpolation processing on image data, which makes the interpolation processing on half-tone dot decision data compatible with the scaling interpolation processing on the image data all the time, making it possible to transmit the half-tone dot decision data in the same condition as that of the image data.

An eighth aspect of the present invention is an image signal processing apparatus comprising a data input section that inputs image data, a half-tone dot decision information adding section that sequentially references a predetermined reference range of image data input from the input section, decides whether the image data is a half-tone dot image or not, adds the half-tone dot decision result data to image data located in the center of the reference range and outputs the image data and the half-tone dot decision result data synchronously, a space filter processing section that inputs the image data and half-tone dot decision result data sequentially output from the half-tone dot decision information adding section, applies space filter processing with reference to a predetermined range of the input image data, adjusts the image position of the image data subjected to the space filter processing in such a way as to match the image position of the input half-tone dot decision result data and outputs both data pieces synchronously, and an output section that outputs the image data and half-tone dot decision result data sequentially output from the space processing section to the outside.

Adopting such a configuration allows the space filter processing section to adjust the image position of the image data subjected to the space filter processing in such a way as to match the image position of the input half-tone dot decision result data and outputs both data pieces synchronously, thus making it possible to transmit the half-tone dot decision result data even when the image data is subjected to space filtering processing.

A ninth aspect of the present invention is an image signal processing apparatus comprising a data input section that inputs image data, a half-tone dot decision information adding section that sequentially references a predetermined reference range of image data input from the input section, decides whether the image data is a half-tone dot image or not, adds the half-tone dot decision result data to image data located in the center of the reference range and outputs the image data and the half-tone dot decision result data synchronously, a first and second image processing sections that performs predetermined image processing using the synchronously input image data and half-tone dot decision result data, adjusts the image position of the image data subjected to the image processing in such a way as to match the image position of the half-tone dot decision result data and outputs both data pieces synchronously, a first data selection section that receives a second pair of the image data and the half-tone dot decision result data output from the second image processing section as an inputs, receives a third data pair of the image data and the half-tone dot decision result data output from the half-tone dot decision information adding section as the other input and inputs one data pair selected from the two pairs to the first image processing section, a second data selection section that receives a first data pair of the image data and the half-tone dot decision result data output from the first image processing section as one input, receives the third data pair as the other input and inputs one data pair selected from the two pairs to the second image processing section, a third data selection section that receives the first data pair, the second data pair and the third data pair as inputs and selects any one of those data pairs and an output section that outputs the image data and the half-tone dot decision result data selected from the third data selection section to the outside.

Adopting such a configuration makes it possible to carry out a half-tone dot decision through the half-tone dot decision information adding section to acquire half-tone dot decision result data before image processing, carry the first and second image processing sections through the data pair of the image data and half-tone dot decision result data and arbitrarily select the image processing order through the first, second and third selection sections.

A tenth aspect of the present invention is an image signal processing apparatus comprising a data input section that inputs image data, a half-tone dot decision information adding section that sequentially references a predetermined reference range of image data input from the input section, decides whether the image data is a half-tone dot image or not, adds the half-tone dot decision result data to image data located in the center of the reference range and outputs the image data and the half-tone dot decision result data synchronously, a multi-value image data compression/reconstruction section that receives the image data and half-tone dot decision result data sequentially output from the half-tone dot decision information adding section as inputs, codes the image data and half-tone dot decision data into one piece of fixed length data and saves the data in an image storage memory, decodes the data saved in the image storage memory and outputs the image data and half-tone dot decision result data synchronously, and an output section that outputs the image data and the half-tone dot decision result data sequentially output from the multi-value image data compression/reconstruction section to the outside.

Adopting such a configuration makes it possible to carry out a half-tone dot decision through the half-tone dot decision information adding section before multi-value image data compression to acquire the half-tone dot decision result, code a data pair of the image data and half-tone dot decision result data into one piece of fixed length data, save the data in an image storage memory, reconstruct and output the data pair, and thereby transmit the half-tone dot decision result data even when multi-value compression/reconstruction processing is carried out.

An eleventh aspect of the present invention is the image signal processing apparatus according to the tenth aspect, wherein switching between quantization processing used for coding the fixed length data and de-quantization processing used for decoding is carried out using the half-tone dot decision result data.

This makes it possible to switch between the quantization processing used for coding to the fixed length data and the de-quantization processing used for decoding using half-tone dot decision result data, and thereby cut a high frequency base component which may cause moiré at the half-tone dot decision section, assign the number of extra bits as the number of low frequency basic bits and reduce moiré of the reconstructed half-tone dot image section.

A twelfth aspect of the present invention is the image signal processing apparatus according to the tenth aspect, further comprising a block half-tone dot decision section that divides the input half-tone dot decision data into blocks and decides whether each block is a half-tone dot area or non-half-tone dot area based on the count value of the half-tone dot count in the block and a block data generation section that adds the information of the decision result to the fixed-length coded image data.

This makes it possible to decide whether a block is a half-tone dot or non-half-tone dot, add the half-tone dot decision result to the fixed-length coded image data and thereby save the half-tone dot decision result.

A thirteenth aspect, of the present invention is the image signal processing apparatus according to the tenth aspect, further comprising a block half-tone dot decision result memory into which the block half-tone dot decision result is written and a block half-tone dot decision section that counts a half-tone dot decision count of a peripheral block according to the block half-tone dot decision result of the peripheral block read from the block half-tone dot decision result memory and decides whether the block is a non-half-tone dot area or not.

This makes it possible to count the half-tone dot decision count of the peripheral block half-tone dot decisions according to the block half-tone dot decision result of the peripheral block to decide whether the block is a non-half-tone dot area or not, and thereby provide a high accuracy half-tone dot decision.

A fourteenth aspect of the present invention is the image signal processing apparatus according to the tenth aspect, wherein the multi-value image data compression/reconstruction section includes a section that places bits of the half-tone dot decision data near the DC component or AC low frequency component of the image data when the image data and half-tone dot decision data are coded into one fixed-length data and saved in the image storage memory, a variable-length coder that compresses fixed-length data in the image storage memory to variable-length data and a variable-length decoder that decodes the variable-length data to the fixed-length data.

This makes it possible to place bits of the half-tone dot decision data near the DC component or AC low frequency component of the image data, and thereby increase the scale-down ratio if JBIG coding is performed in subsequent sections.

A fifteenth aspect of the present invention is an image signal processing apparatus comprising a data input section that inputs image data, a half-tone dot decision information adding section that sequentially references a predetermined reference range of image data input from the input section, decides whether the image data is a half-tone dot image or not, adds the half-tone dot decision result data to image data located in the center of the reference range and outputs the image data and the half-tone dot decision result data synchronously, and a character/photo/half-tone dot decision section that receives the image data sequentially output from the half-tone dot decision information adding section and half-tone dot decision result data as inputs and decides whether the data is a character, photo or half-tone dot image based on the half-tone dot decision result data and image data.

Adopting such a configuration makes it possible to capture the half-tone dot decision result data and image data and decide whether the data is a character, photo or half-tone dot image, and thereby perform image zoning using the half-tone dot decision result data decided by the preceding section.

A sixteenth aspect of the present invention is the image signal processing apparatus according to the fifteenth aspect, wherein the character/photo/half-tone dot decision section includes a character/photo decision section that decides from the input image data whether the data is a character or photo and an overall decision section that decides whether the data is a character, photo or half-tone dot image from the character/photo decision result and the half-tone dot decision result data input in synchronization with the image data.

This makes it possible to decide from the image data whether the data is a character or photo and separate the half-tone dot image using the half-tone dot decision result data decided in the preceding section.

A seventeenth aspect of the present invention is an image signal processing apparatus comprising a data input section that inputs image data, a half-tone dot decision information adding section that sequentially references a predetermined reference range of image data input from the input section, decides whether the image data is a half-tone dot image or not, adds the half-tone dot decision result data to image data located in the center of the reference range and outputs the image data and the half-tone dot decision result data synchronously, a character/photo/half-tone dot decision section that receives the image data sequentially output from the half-tone dot decision information adding section and half-tone dot decision result data as inputs and decides, based on the half-tone dot decision result data and image data, whether the data is a character, photo or half-tone dot image, an adaptive half-tone processing section that selects half-tone processing from the image zoning decision result and an output section that outputs the image data subjected to the half-tone processed image data to the outside.

Adopting such a configuration makes it possible to decide from the half-tone dot decision result data and image data whether the data is a character, photo or half-tone dot image and select the half-tone processing from the image zoning decision result.

A eighteenth aspect of the present invention is an image signal processing apparatus comprising a data input section that inputs image data, a half-tone dot decision information adding section that sequentially references a predetermined reference range of image data input from the input section, decides whether the image data is a half-tone dot image or not, adds the half-tone dot decision result data to image data located in the center of the reference range and outputs the image data and the half-tone dot decision result data synchronously, a character/photo/half-tone dot decision section that receives the image data sequentially output from the half-tone dot decision information adding section and half-tone dot decision result data as inputs and decides, based on the half-tone dot decision result data and image data, whether the data is a character, photo or half-tone dot image, a character/photo/half-tone dot correspondence PWM control section that switches between PWM cyclic control and PWM data based on the image zoning decision result and an output section that outputs the control signal and the image data subjected to the PWM control.

Adopting such a configuration makes it possible to decide whether the data is a character, photo or half-tone dot image from the half-tone dot decision result data and image data and switch between the PWM cyclic control and PWM data based on the image zoning decision result.

A nineteenth aspect of the present invention is the image signal processing apparatus according to the eighteenth aspect, wherein when the decision result from the character/photo/half-tone dot decision section shows that the data is a half-tone dot, the PWM data is subjected to moiré elimination filter processing.

In the case of a half-tone dot decision, this makes it possible to apply moiré elimination filter processing to the PWM data and thereby reduce the generation of moiré.

### BRIEF DESCRIPTION OF THE DRAWINGS

The above objects and features of the invention will appear more fully hereinafter from a consideration of the following description taken in connection with the accompanying drawing wherein one example is illustrated by way of example, in which;

FIG. 1 shows an overall block diagram of an image signal processing apparatus according to Embodiment 1 of the present invention;

FIG. 2 is a block diagram of a half-tone dot decision information adding circuit in the image signal processing apparatus according to Embodiment 1;

FIG. 3 is a block diagram of a convolutional calculation circuit in the half-tone dot decision information adding circuit shown in FIG. 2;

FIG. 4 is a block diagram of a multiplier in the convolutional calculation circuit shown in FIG. 3;

FIGS. 5A to 5D illustrates patterns of a two-dimensional DFT coefficient in the half-tone dot decision information adding circuit shown in FIG. 2;

FIG. 6 is a block diagram of a scaling circuit in the image signal processing apparatus according to Embodiment 1;

FIG. 7 illustrates a logical value table for data path control in the image signal processing apparatus according to Embodiment 1;

FIG. 8 illustrates a logical value table for line memory control in the image signal processing apparatus according to Embodiment 1;

FIG. 9 illustrates a time chart in a sub-scanning scale-down interpolation mode in Embodiment 1 above;

FIG. 10 illustrates a time chart of the rest of FIG. 9 in the sub-scanning scale-down mode interpolation in Embodiment 1 above;

FIG. 11 illustrates another time chart in the sub-scanning scale-down interpolation mode in Embodiment 1 above;

FIG. 12 illustrates a time chart of the rest of FIG. 11 in the sub-scanning scale-down interpolation mode in Embodiment 1 above;

FIG. 13 illustrates another time chart in the sub-scanning scale-down interpolation mode in Embodiment 1 above;

FIG. 14 illustrates a time chart of the rest of FIG. 13 in the sub-scanning scale-down interpolation mode in Embodiment 1 above;

FIG. 15 is a block diagram of a main scanning side block of the scaling control circuit in Embodiment 1 above;

FIG. 16 is a block diagram of a sub-scanning side block of the scaling control circuit in Embodiment 1 above;

FIG. 17 illustrates a timing chart of main scanning scale-up processing in Embodiment 1 above;

FIG. 18 illustrates a timing chart of main scanning scale-down processing in Embodiment 1 above;

FIG. 19 is a block diagram of the main scanning scale-down interpolation circuit in the image signal processing apparatus according to Embodiment 1;

FIG. 20 is a block diagram of the main scanning scale-up interpolation circuit in the image signal processing apparatus according to Embodiment 1;

FIG. 21 is a block diagram of the sub-scanning scale-down interpolation circuit in the image signal processing apparatus according to Embodiment 1;

FIG. 22 is a block diagram of a character/photo/half-tone dot decision circuit in the image signal processing apparatus according to Embodiment 1;

FIG. 23 illustrates an overall decision logical table in the character/photo/half-tone dot decision circuit shown in FIG. 22;

FIG. 24 is a block diagram of a character/photo/half-tone dot correspondence half-tone processing circuit in the image signal processing apparatus according to Embodiment 1;

FIG. 25 illustrates an overall block diagram of an image signal processing apparatus according to Embodiment 2 of the present invention;

FIG. 26 is a block diagram of a multi-value image data compression/reconstruction circuit in the image signal processing apparatus according to Embodiment 2;

FIG. 27 is a conceptual view of quantization processing through block half-tone dot decision in the multi-value image data compression/reconstruction circuit;

FIG. 28 is a data array of bitmap data in the multi-value image data compression/reconstruction circuit;

FIG. 29 shows bitmap data banded by frequency in the multi-value image data compression/reconstruction circuit;

FIG. 30 is a conceptual view of HAAR conversion in the multi-value image data compression/reconstruction circuit;

FIG. 31 is a conceptual view of de-quantization processing through block half-tone dot decision in the multi-value image data compression/reconstruction circuit;

FIG. 32 is a conceptual view of de-HAAR conversion in the multi-value image data compression/reconstruction circuit;

FIG. 33 is a block diagram of a modification example of the multi-value image data compression/reconstruction circuit in the image signal processing apparatus according to Embodiment 2;

FIG. 34 is a conceptual view of a block half-tone dot decision system in the multi-value image data compression/reconstruction circuit shown in FIG. 33;

FIG. 35 is a block diagram of a character/photo/half-tone dot correspondence PWM control circuit in the image signal processing apparatus according to Embodiment 2; and

FIG. 36 shows a character/photo/half-tone dot correspondence PWM control timing chart of the circuit shown in FIG. 35.

### DETAILED DESCRIPTION OF THE PREFERRED EMBODIMENTS

With reference now to the attached drawings, embodiments of an image signal processing apparatus of the present invention will be explained in detail below.

(Embodiment 1)

This Embodiment 1 is an example of performing image zoning processing after various kinds of image processing and applying half-tone processing suited to images.

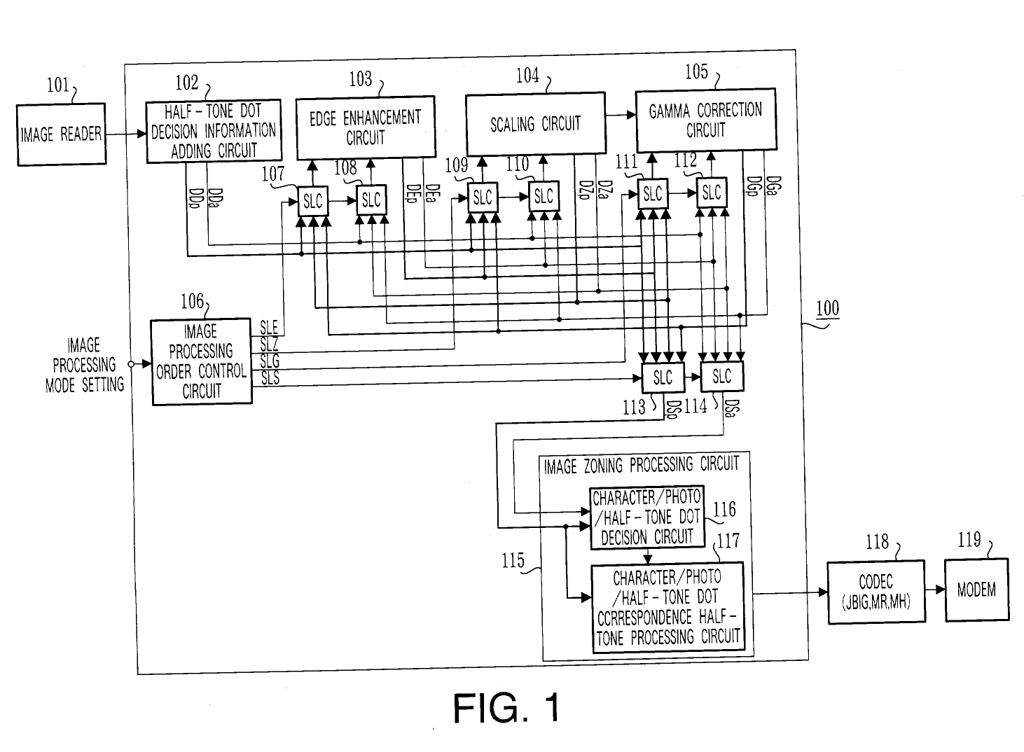

FIG. 1 shows an overall block diagram of an image signal processing apparatus according to Embodiment 1. The image signal processing apparatus 100 uses image data read by an image reader 101 as an input image. The image signal processing apparatus 100 is constructed in such a way that the input image is supplied to a half-tone dot decision information adding circuit 102 first, subjected to a half-tone dot decision and then supplied to each image processing block (edge enhancement circuit 103, scaling circuit 104, gamma correction circuit 105).

The half-tone dot decision information adding circuit 102 decides whether each pixel is a half-tone dot image or not, and outputs the decision result as half-tone dot information data DDa to other image processing blocks in synchronization with image data DDp.

The input sections of the edge enhancement circuit 103, scaling circuit 104 and gamma correction circuit 105 are provided with pairs of selectors (107, 108), (109, 110), (111, 112), respectively. One selector (107, 109, 111) is fed image data output from the half-tone dot decision information adding circuit 102 and processing results output from the other image processing blocks (103, 104, 105) and the other selector (108, 110, 112) is fed decision result output from the half-tone dot decision information adding circuit 102 and the half-tone dot information data output from the other image processing blocks (103, 104, 105) in synchronization with the image processing data.

The order in which image data is input to each image processing block (103, 104, 105) is determined by the image processing order control circuit 106 controlling one selector (107, 109, 111). Furthermore, the image processing order control circuit 106 controls the other selector (108, 110, 112) so that the corresponding half-tone dot image data is input to each image processing block (103, 104, 105) in synchronization with the image data. Furthermore, the image processing order control circuit 106 controls a pair of selectors 113 and 114 so that the image processing result and the corresponding half-tone dot information data are output to an image zoning processing circuit 115 that follows.

The image zoning processing circuit 115 is constructed of a character/photo/half-tone dot decision circuit 116 and a character/photo/half-tone dot correspondence half-tone processing circuit 117. By the way, this embodiment is constructed in such a way that the output signal of the character/photo/half-tone dot correspondence half-tone processing circuit 117 is coded by a CODEC circuit 118 and then sent through a modem 119. Processes from the character/photo/half-tone dot correspondence half-tone processing circuit 117 on are modifiable according to applications and not limited to the case where data is transmitted.

Then, an outline of operation of this embodiment in the above-described configuration will be explained.

Before the image data read by the image reader 101 is processed by each image processing block (103, 104, 105), the image data is subjected to a half-tone dot decision for each pixel by the half-tone dot decision information adding circuit 102. The image data and half-tone dot information data are input to each image processing block (103, 104, 105) in a predetermined order under the control of the image processing order control circuit 106 and the image data is subjected to their corresponding image processing. Then, image data DSp for which image processing in an arbitrary image processing order has been completed and the corresponding half-tone dot information data DSa are input to the character/photo/half-tone dot decision circuit 116 of the image zoning processing circuit 115 and the character/photo/half-tone dot correspondence half-tone processing circuit 117. However, only image data is input to the character/photo/half-tone dot correspondence half-tone processing circuit 117.

The character/photo/half-tone dot decision circuit 116 decides whether each pixel is a character, photo or half-tone dot photo based on the half-tone dot information data DSa. More specifically, it decides whether the input pixel is a half-tone dot photo or not using the half-tone dot information data DSa first, and further decides whether the pixel decided to be a non-half-tone dot photo is a photo or character from the feature (amount of variation from neighboring pixels, spatial frequency distribution, etc.) of the image data DSp.

The character/photo/half-tone dot correspondence half-tone processing circuit 117 selects the optimal half-tone processing for each pixel according to the decision result (character, photo, half-tone dot) output from the character/photo/half-tone dot decision circuit 116.

An example of selection of half-tone processing will be shown. For example, the character/photo/half-tone dot correspondence half-tone processing circuit 117 carries out binarization for a character decision result, photo half-tone processing for a photo decision result, and half-tone dot image half-tone processing for a half-tone dot decision result after moiré suppression filter processing. This makes it possible to obtain a half-tone image with high resolution/sharpness in the character section, a high-level gradation characteristic in the photo section and high-level gradation characteristic free of moiré in the half-tone dot section.

Next, a more specific configuration and operation of the half-tone dot decision information adding circuit 102 will be explained.

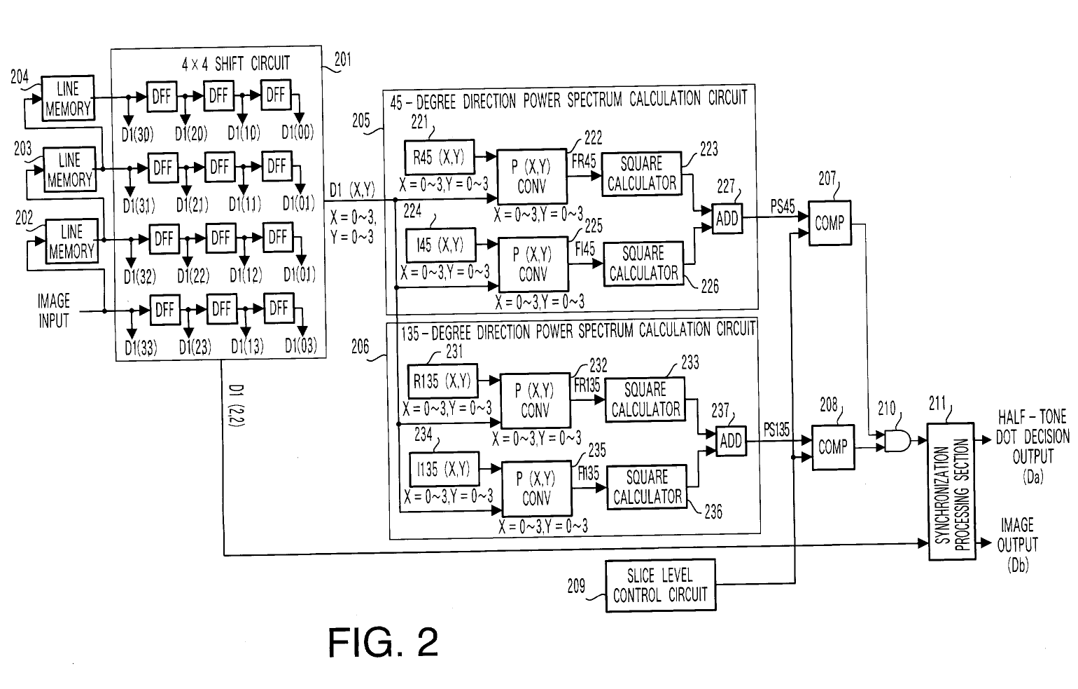

FIG. 2 is a block diagram of the half-tone dot decision information adding circuit 102. The half-tone dot decision information adding circuit 102 is constructed in such a way that three line memories 202, 203 and 204 are connected in series to the input sections of a 4×4 shift circuit 201 to generate 4×4 pixel data. The output section of the 4×4 shift circuit 201 is connected to a 45-degree direction power spectrum calculation circuit 205 and a 135-degree direction power spectrum calculation circuit 206 in parallel. The 45-degree direction power spectrum calculation circuit 205 is a circuit to calculate a power spectrum in a 45-degree direction around a target pixel and the 135-degree direction power spectrum calculation circuit 206 is a circuit to calculate a power spectrum in a 135-degree direction around a target pixel. When the power spectrum in the 45-degree direction around a target pixel and the power spectrum in the 135-degree direction are equal to or higher than a predetermined slice level, the target pixel is decided to be a half-tone dot photo.

The 45-degree direction power spectrum calculation circuit 205 includes a coefficient generator 221 that generates a two-dimensional DFT coefficient of an R component, a convolutional calculator 222 that performs a convolutional calculation on the two-dimensional DFT coefficient generated by this coefficient generator 221 and the 4×4 image data output from the 4×4 shift circuit 201 and a square calculator 223 that calculates the square of the output of the convolutional calculator 222. The 45-degree direction power spectrum calculation circuit 205 further includes a coefficient generator 224 that generates a two-dimensional DFT coefficient of an I component, a convolutional calculator 225 that performs a convolutional calculation on the two-dimensional DFT coefficient generated by this coefficient generator 224 and the 4×4 image data output from the 4×4 shift circuit 201 and a square calculator 226 that calculates the square of the output of the convolutional calculator 225. Furthermore, it also includes an adder 227 that adds up the outputs of the square calculators 223 and 226.

The 135-degree direction power spectrum calculation circuit 206 is constructed in the same way as the 45-degree direction power spectrum calculation circuit 205. That is, the 135-degree direction power spectrum calculation circuit 206 includes a coefficient generator 231 that generates a two-dimensional DFT coefficient of an R component, a convolutional calculator 232 that performs a convolutional calculation on the two-dimensional DFT coefficient and the 4×4 image data output from the 4×4 shift circuit 201 and a square calculator 233 that calculates the square of the output of the convolutional calculator 232. The 135-degree direction power spectrum calculation circuit 206 further includes a coefficient generator 234 that generates a two-dimensional DFT coefficient of an I component, a convolutional calculator 235 that performs a convolutional calculation on the two-dimensional DFT coefficient generated by this coefficient generator 234 and the 4×4 image data output from the 4×4 shift circuit 201 and a square calculator 236 that calculates the square of the output of the convolutional calculator 235. Furthermore, it also includes an adder 237 that adds up the outputs of the square calculators 233 and 236.

The 45-degree direction power spectrum calculation circuit 205 and the 135-degree direction power spectrum calculation circuit 206 configured as shown above execute calculations according to the following expression.

$$\begin{matrix}F 45 R = {\sum }_{X = 0}^{3} {\sum }_{Y = 0}^{3} ( R 45 ( X , Y ) \times D 1 ( X , Y ) ) \\ F 45 I = {\sum }_{X = 0}^{3} {\sum }_{Y = 0}^{3} ( I 45 ( X , Y ) \times D 1 ( X , Y ) ) \\ PS 45 = F 45 {R}^{2} + F 45 {I}^{2} \\ F 135 R = {\sum }_{X = 0}^{3} {\sum }_{Y = 0}^{3} ( R 135 ( X , Y ) \times D 1 ( X , Y ) ) \\ F 135 I = {\sum }_{X = 0}^{3} {\sum }_{Y = 0}^{3} ( I 135 ( X , Y ) \times D 1 ( X , Y ) ) \\ PS 135 = F 135 {R}^{2} + F 135 {I}^{2}\end{matrix}$$

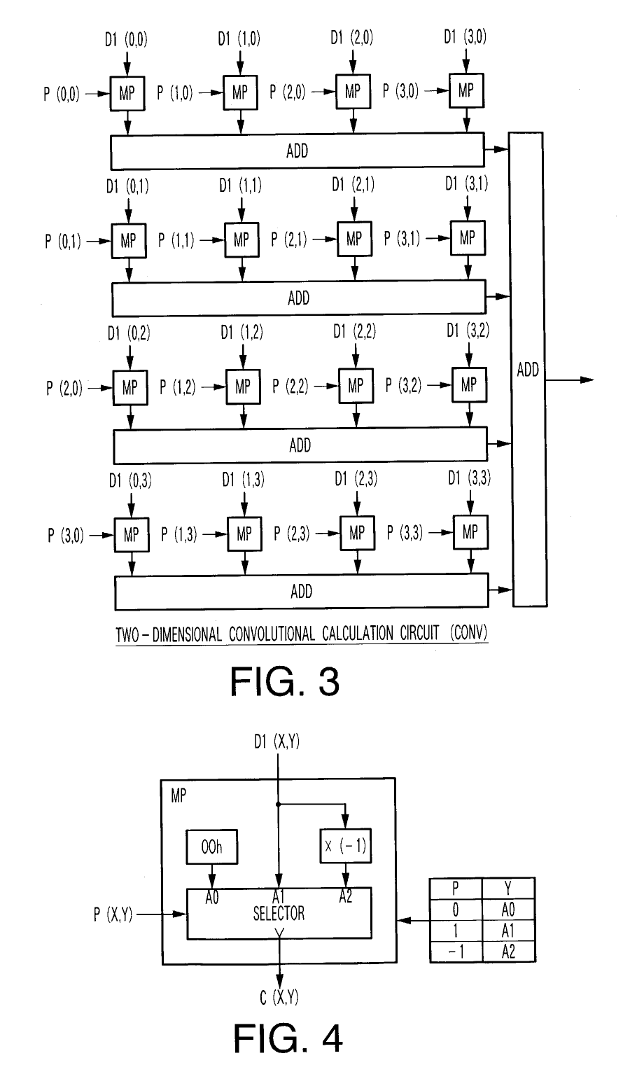

FIG. 3 shows a configuration of the convolutional calculation circuits 222 and 232 and FIG. 4 shows a configuration of a multiplier (MP) built in the convolutional calculation circuits 222 and 232. Since P(X, Y) of the multiplier (MP) takes only values 0and ±1, a circuit configuration using a selector is possible.

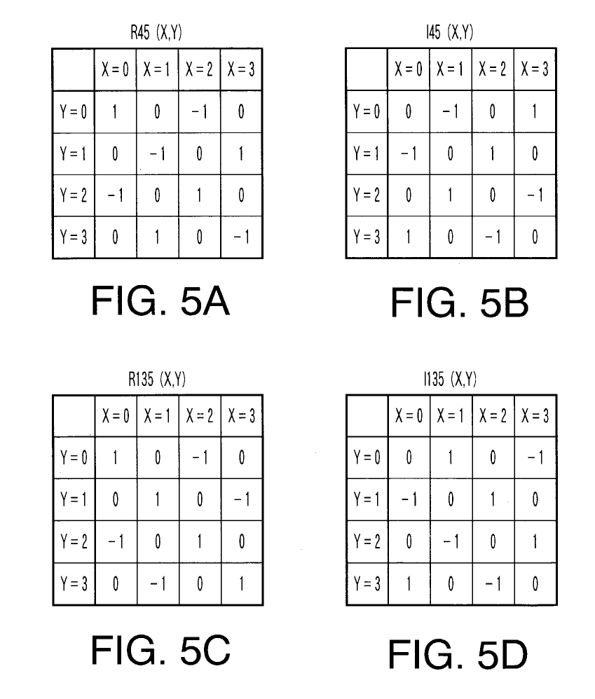

FIGS. 5A to 5D show examples of table data of R45 (X, Y), I45 (X, Y), R135 (X, Y) and I135 (X, Y) to be input to the convolutional calculation circuits 222 and 232. FIG. 5A shows a coefficient pattern generated by the coefficient generator 221, FIG. 5B shows a coefficient pattern generated by the coefficient generator 224, FIG. 5C shows a coefficient pattern generated by the coefficient generator 231 and FIG. 5D shows a coefficient pattern generated by the coefficient generator 234.

Thus, the calculation result output from the 45-degree direction power spectrum calculation circuit 205 is output to a comparator 207 and the calculation result output from the 135-degree direction power spectrum calculation circuit 206 is output to a comparator 208.

A slice level control circuit 209 sets slice levels in the comparators 207 and 208. The outputs of the comparators 207 and 208 are output to a synchronization processing section 211 through an AND gate 210. The synchronization processing section 211 outputs half-tone dot decision information Da which becomes a half-tone dot decision result and pixel data Dp of the target pixel synchronously.

Thus, the input image data is converted to 16 data D1 (X, Y) points surrounding the target pixel (D1 (2, 2)) in a 4×4 square form, a 45-degree direction or 135-degree direction power spectrum with respect to the target pixel is obtained and if the respective values are equal to or greater than a predetermined value, the target pixel is decided to be a half-tone dot photo. The half-tone dot information data Da which is a half-tone dot decision result is output in synchronization with the pixel data Dp of the target pixel, and therefore it is possible to obtain information data Da for each pixel from the image data before image processing and provide the subsequent image processing blocks with a combination of the half-tone dot decision information Da and image data Dp of the target pixel.

Then, the fact that the above-described image processing blocks 103, 104 and 105 carry half-tone dot information data as well as image data will be explained taking the scaling circuit 104 as an example.

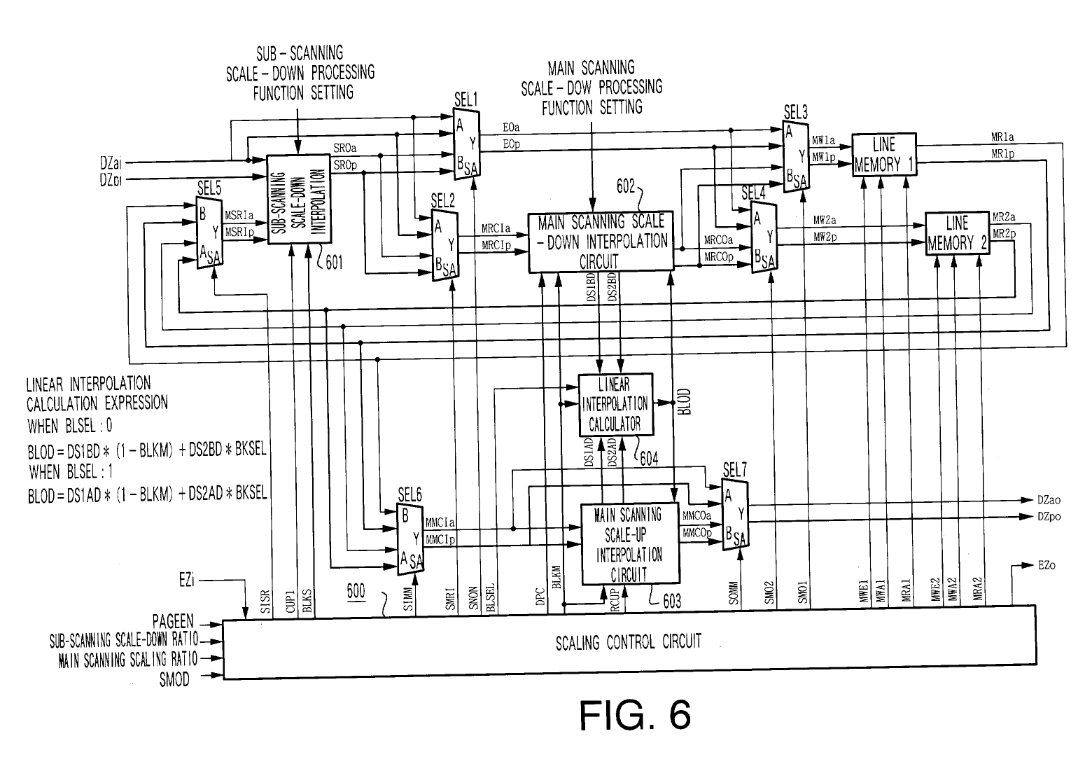

FIG. 6 shows an overall configuration of the scaling circuit 104. In the scaling circuit 104 shown in the same figure, the selection statuses of selectors (SEL1, SEL2, SEL3, SEL4, SEL5, SEL6, SEL7) are controlled by data path control signals (SISR, SIMM, SNON, SMRI, SMO1, SMO2, SOMM) generated from the scaling control circuit 600 and the connection relationship among the sub-scanning scale-down interpolation circuit 601, main scanning scale-down interpolation circuit 602, line memory 1, line memory 2 and main scanning scale-up interpolation circuit 603 is determined according to the selection statuses. The above-described connection relationship determines the processing channel (hereinafter referred to as “data path”) of the image data (DZpi) input to this scaling processing circuit. The input image data (DZpi) and half-tone dot information data (DZai) are output from the selector (SEL7) through a data path determined by the scaling control circuit 600 as image data (DZpo) and half-tone dot information data (DZao).

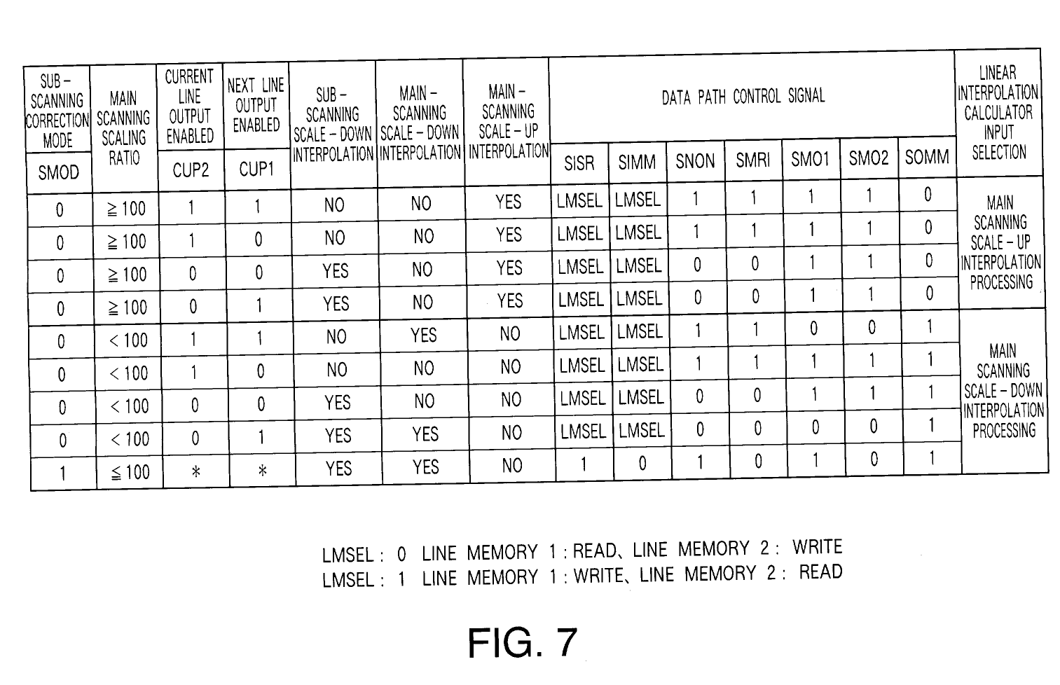

The scaling control circuit 600 is fed a page enable signal (PAGEEN), line enable signal (EZi), main scanning scaling ratio data, sub-scanning scale-down ratio data and sub-scanning interpolation mode (SMOD). Data path control signals (SISR, SIMM, SNON, SMRI, SMO1, SMO2, SOMM) are generated for every 1-line cycle decided by the line enable signal (EZi). By the way, the data path control signals are controlled according to a “data path control signal” truth table shown in FIG. 7.

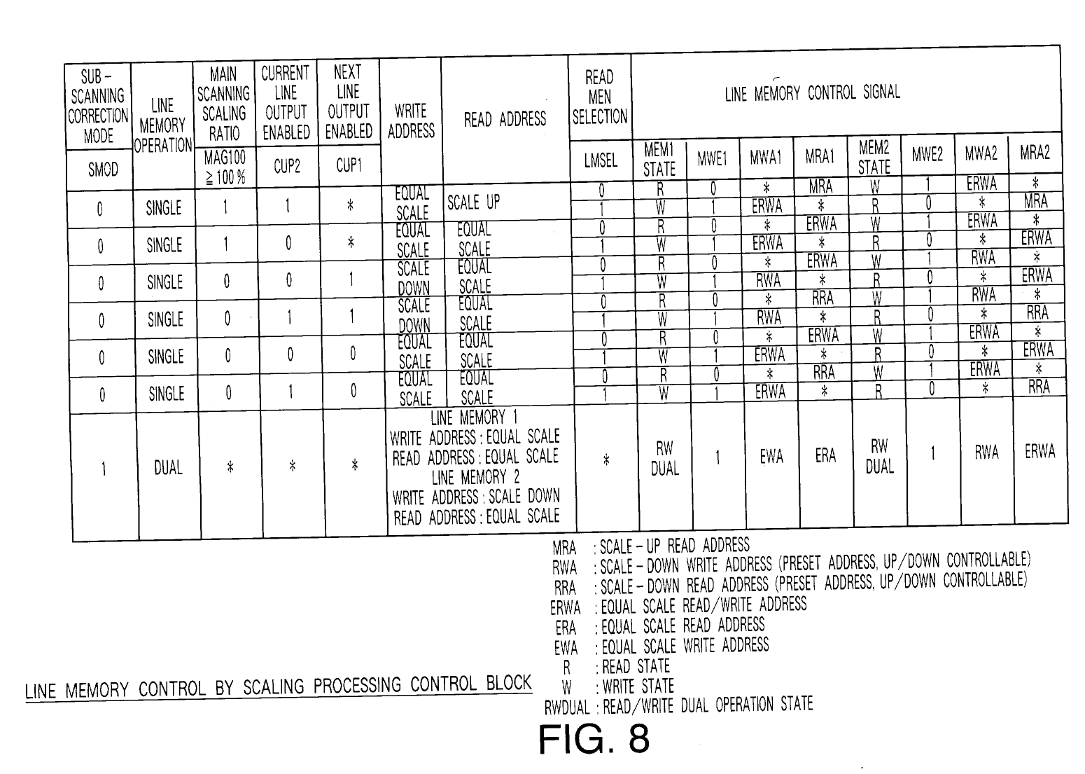

Furthermore, the scaling control circuit 600 generates line memory control signals for the line memory 1 and line memory 2. The scaling control circuit 600 generates write enable (MWE1), write address (MWA1) and read address (MRA1) for the line memory 1, and a write enable (MWE2), write address (MWA2) and read address (MRA2) for line memory 2. The line memory control signal is controlled for every one-line cycle determined by the line enable signal (EZi). By the way, the line memory control signal is controlled according to the “line memory control signal” truth table shown in FIG. 8.

Furthermore, a sub-scanning scale-down processing function setting is input to the sub-scanning scale-down interpolation circuit 601 to determine the sub-scanning scale-down correction function. A main scanning scale-down processing function setting is input to the main scanning scale-down interpolation circuit 602 to determine the main scanning scale-down correction function. A linear interpolation calculator 604 is shared between the main scanning scale-down interpolation circuit 602 and main scanning scale-up interpolation circuit 603 and when the main scanning scale-down ratio is 100% or more, an interpolation calculation is carried out with data (DS1AD, DS2AD) from the main scanning scale-up interpolation circuit 603 and when the main scanning scale-down ratio is less than 100%, an interpolation calculation is carried out with data (DS1BD, DS2BD) from the main scanning scale-down interpolation circuit 602.

Then, the basic operation of the scaling processing circuit in the above-described configuration will be explained. In the scaling processing circuit of this embodiment, the main scanning scaling interpolation processing is executed by the main scanning scale-up interpolation circuit 603 and main scanning scale-down interpolation circuit 602 separately. Scale-down interpolation processing by the main scanning scale-down interpolation circuit 602 is executed before data is written to the line memory 1 or line memory 2, while scale-up interpolation processing by the main scanning scale-up interpolation circuit 603 is executed after data is read from the line memory 1 or line memory 2.

During scaling down in the main/sub-scanning direction, the count-up cycle of write addresses of line memories 1 and 2 is slower than the data input cycle according to the scale-down ratio and scale-down processing is executed by overwriting a plurality of data pieces at the same address.

During scaling up in the main scanning direction, the count-up cycle of read addresses of line memories 1 and 2 is slower than the data input cycle according to the scale-up ratio and scale-up processing is executed by reading data at the same address a plurality of times.

Implementing such main scanning scale-up processing no longer requires any line memory faster than the data input cycle and can thereby lift restrictions on the main scanning scaling ratio due to a data rate.

Furthermore, enabling/disabling of image data output on the current line and enabling/disabling of the image data output on the next line are calculated for each data input line. “Enabling image data output” means outputting the image data from the scaling processing circuit. On the other hand, “disabling image data output” means that the image data is not to be output from the scaling processing circuit due to scale-down processing or interpolation processing.

According to the above-described four statuses, enabling/disabling of sub-scanning scale-down interpolation processing by the sub-scanning scale-down interpolation circuit 601, main scanning scale-down interpolation processing by the main scanning scale-down interpolation circuit 602 and main-scanning scale-up interpolation processing by the main scanning scale-up interpolation circuit 603 and scale-down write and scale-up read on the line memories 1 and 2 are controlled.

This makes it possible to share the line memory necessary for main scanning scaling processing and the line memory necessary for sub-scanning scale-down interpolation processing for each input line of the image data on a time-division basis so that the two line memories 1 and 2 can be used for such processing.

Furthermore, main scanning scale-down interpolation processing by the main scanning scale-down interpolation circuit 602 and scale-down writes to the line memories 1 and 2 are executed only when the image data output on the next line is enabled and when the image data output on the next line is disabled, equal scale writes to the line memories 1 and 2 are executed without carrying out main scanning scale-down interpolation processing.

Furthermore, only when the image data output on the current line is enabled, main scanning scale-up interpolation processing by the main scanning scale-up interpolation circuit 603 and scale-up reads from the line memories 1 and 2 are executed and data is sent to the subsequent main scanning scale-down interpolation circuit 602 without carrying out sub-scanning scale-down interpolation on the input image data.

Furthermore, when image data on the current line is disabled, the data in the main scanning line memory is read on equal scale and the read data is input to the sub-scanning scale-down interpolation circuit 601 without executing main scanning scale-up interpolation processing, interpolation processing with the image data input from the other one is executed and then the data is sent to the subsequent main scanning scale-down interpolation circuit 602.

Then, the main scanning scaling control and sub-scanning scale-down control by the above-described scaling processing circuit will be explained in detail.

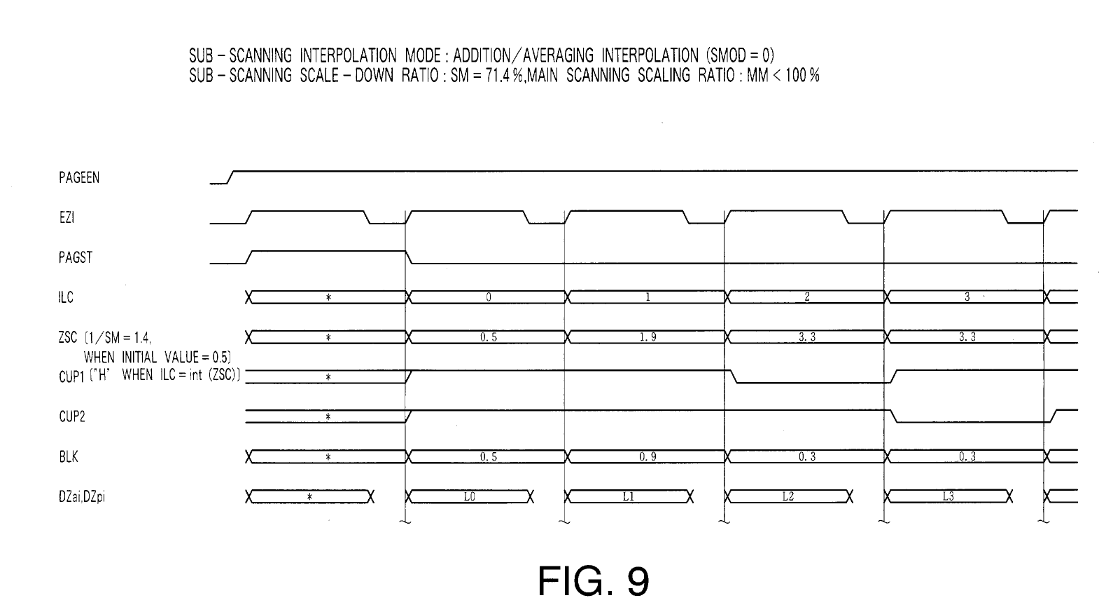

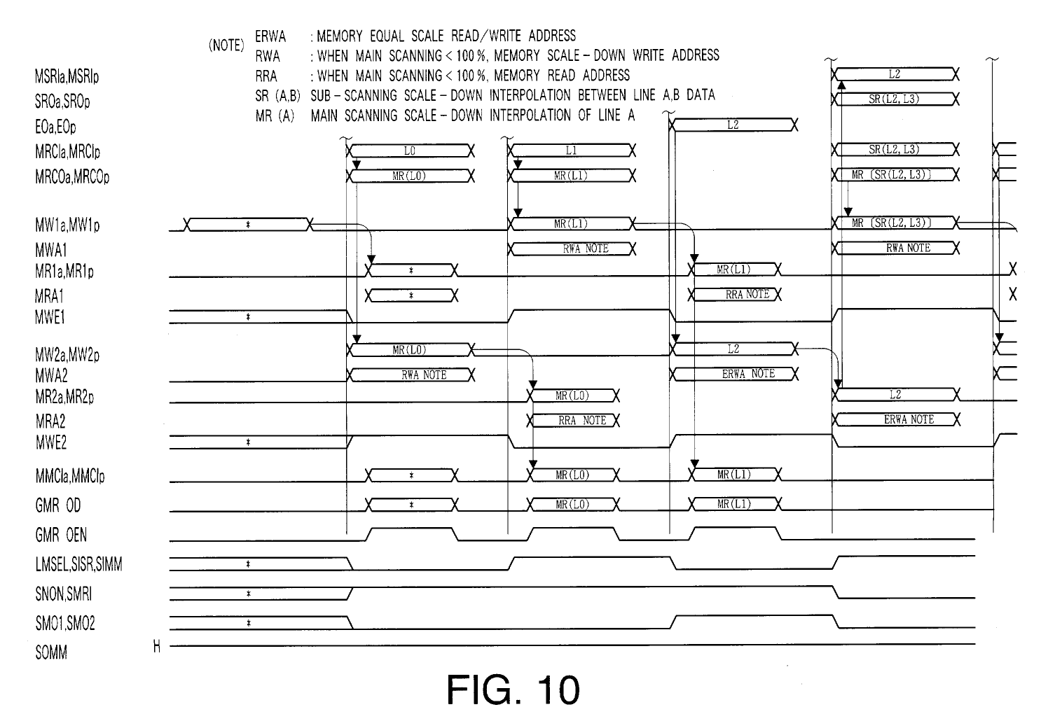

FIG. 9 and FIG. 10 show a timing chart when the sub-scanning interpolation mode is addition/averaging interpolation (SMOD=0), the sub-scanning scale-down ratio is less than 100% (71.4% in this example) and the main scanning scaling ratio is less than 100%. The timing chart shown in FIG. 9 is continuous with the timing chart shown in FIG. 10.

The scaling control circuit 600 decides whether or not to output data from the scaling processing circuit according to the sub-scanning scale-down ratio at the rising timing of a line enable signal (EZi).

In the timing chart shown in FIG. 9, CUP2=1 indicates that data is output and CUP2=0 indicates that data is not output. Furthermore, CUP1 indicates a state in which the next line is output, and CUP1=1 indicates that data on the next line is output and CUP1=0 indicates that data on the next line is not output. Generations of CUP1 and CUP2 at the scaling control circuit 600 will be described later.

a) A data path when the current line is output (CUP2=1) and the next line is output (CUP1=1) will be explained.

Image data (DZpi) and half-tone dot information data (DZai) input do not pass through the sub-scanning scale-down interpolation circuit 601 but are input to the main scanning scale-down interpolation circuit 602 through the selector (SEL2) and scale-down interpolation processing in the main scanning direction is executed. Data is written to either the line memory 1 or line memory 2. The data written one line before is read from the remaining one line memory. The write address corresponding to the line memory at this time is RWA as shown in FIG. 10 and may or may not be counted up at an input image data clock (CKVD) according to the main scanning scale-down ratio. In the case of no count up, data is overwritten at the same address and the previously written data is deleted (scale-down write control).

On the other hand, the read address is ERWA and counted up in synchronization with the input image data clock (CKVD). The image data read from the line memory 1 or line memory 2 and half-tone dot information data do not pass through the main scanning scale-up interpolation circuit 603, but is output as image data (DZpo) and half-tone dot information data (DZao) through the selector (SEL7).

b) A data path when the current line is output (CUP2=1) and the next line is not output (CUP1=0) will be explained.

Image data (DZpi) and half-tone dot information data (DZai) input do not pass through the sub-scanning scale-down interpolation circuit 601 or the main scanning scale-down interpolation circuit 602 but are written to either the line memory 1 or line memory 2 through the selector (SEL1). The data written one line before is read from the remaining one line memory. The write address corresponding to the line memory at this time is ERWA as shown in FIG. 10 and counted up in synchronization with the input image data clock (CKVD).

The image data and half-tone dot information data read from the line memory 1 or line memory 2 are output as image data (DZpo) and half-tone dot information data (DZao) without passing through-the main scanning scale-up interpolation circuit 603 through the selector (SEL7).

c) A data path when the current line is not output (CUP2=0) and the next line is output (CUP1=1) will be explained.

Image data (DZpi) and half-tone dot information data (DZai) input are input to one side of the sub-scanning scale-down interpolation circuit 601. The image data and half-tone dot information data read from either one of the line memory 1 or line memory 2 under a control which will be described later are input to the other side of the sub-scanning scale-down interpolation circuit 601 through the selector (SEL5). The sub-scanning scale-down interpolation circuit 601 performs sub-scanning scale-down interpolation processing between the image data and half-tone dot information data input from the above-described external source and the image data and half-tone dot information data fed back this time. The image data which is the result of the sub-scanning scale-down interpolation processing is input to the main scanning scale-down interpolation circuit 602 through the selector (SEL2), subjected to scale-down interpolation processing in the main scanning direction and then written to either the line memory 1 or line memory 2. The data written one line before is read from the remaining one line memory. The write address corresponding to the line memory at this time is RWA as shown in FIG. 10 and may or may not be counted up according to the main scanning scale-down ratio in synchronization with the input image data clock (CKVD) (scale-down write control). Furthermore, the read address is ERWA and counted up in synchronization with the input image data clock (CKVD). The image data and half-tone dot information data read from the line memory 1 or line memory 2 are input to the aforementioned selector (SEL5). At this data path, neither the image data (DZpo) nor half-tone dot information data (DZao) is output.

d) A data path when the current line is not output (CUP2=0) and the next line is not output (CUP1=0) will be explained. Data output occurs at a sub-scanning scale-down ratio<50% and does not exist in FIG. 9 and FIG. 10.

Image data (DZpi) and half-tone dot information data (DZai) input are input to one side of the sub-scanning scale-down interpolation circuit 601. The image data and half-tone dot information data read from either one of the line memory 1 or line memory 2 under a control which will be described later is input to the other side of the sub-scanning scale-down interpolation circuit 601 through the selector (SEL5) and sub-scanning scale-down interpolation processing is carried out between both the image data and half-tone dot information data. The result of the sub-scanning scale-down interpolation processing is written to either the line memory 1 or line memory 2 through the selector (SEL2) without passing through the main scanning scale-down interpolation circuit 602. The data written one line before is read from the remaining one line memory. The write address and read address corresponding to the line memory at this time are ERWA as shown in FIG. 10 and counted up in synchronization with the input image data clock (CKVD).

The image data and half-tone dot information data read from the line memory 1 or line memory 2 is input to the selector (SEL5) as described above. At this data path, neither the image data (DZpo) nor half-tone dot information data (DZao) is output.

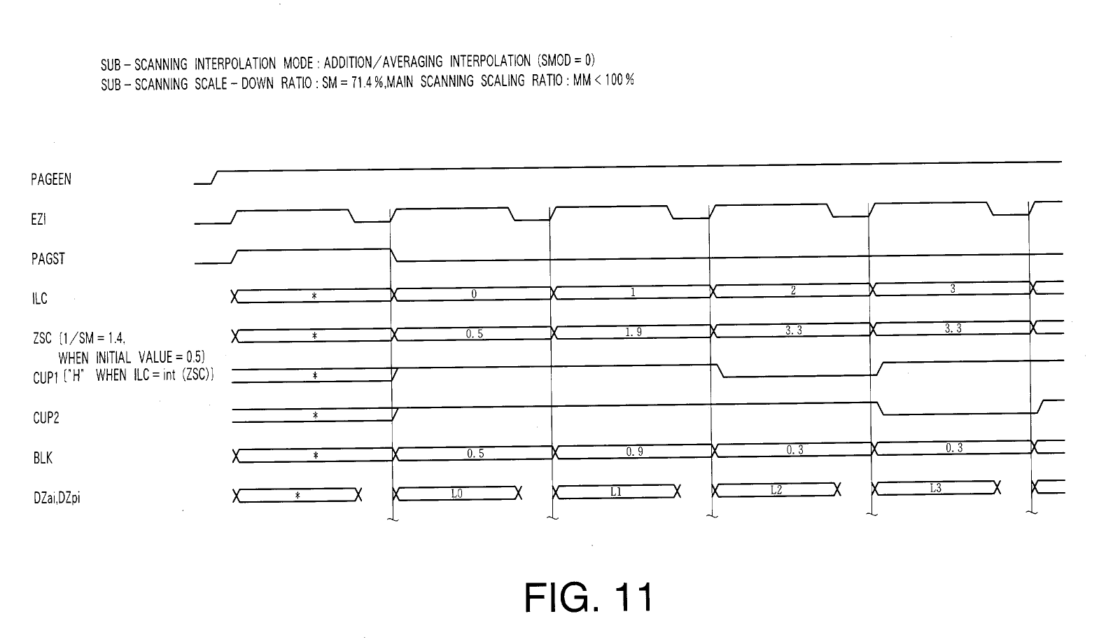

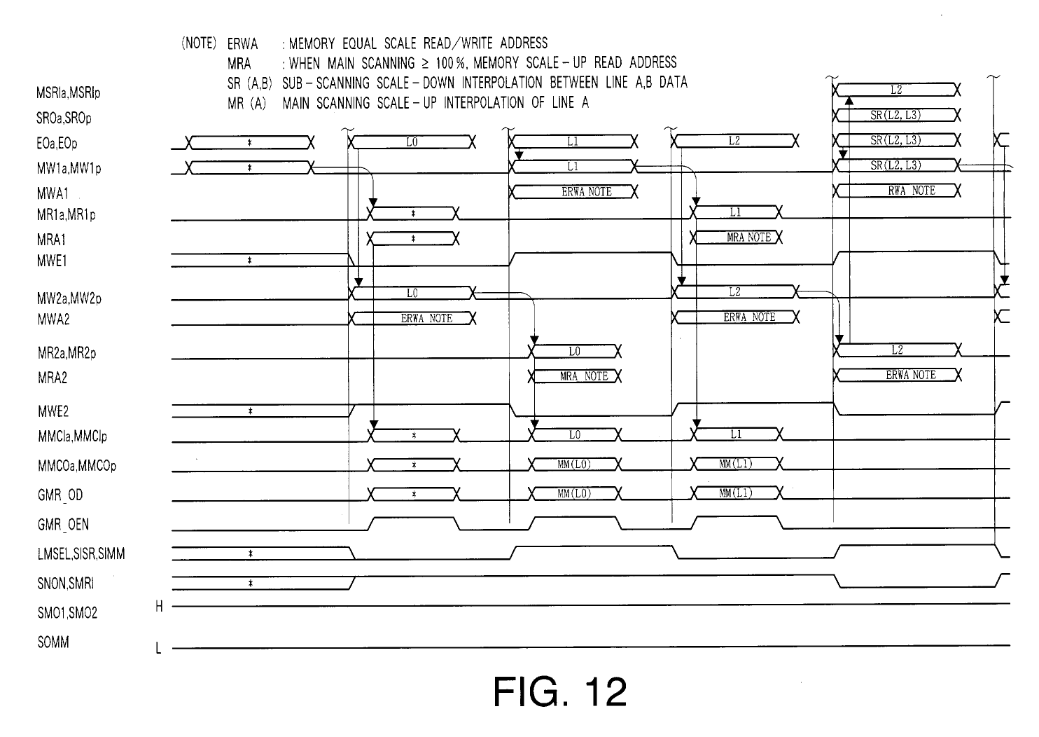

FIG. 11 and FIG. 12 show timing charts when the sub-scanning interpolation mode is addition/averaging interpolation (SMOD=0) and the sub-scanning scale-down ratio is less than 100% (71.4% in the example) and the main scanning scale-down ratio is 100% or more.

The scaling control circuit 600 decides whether or not to output data from the scaling processing circuit 600 according to the sub-scanning scale-down ratio at the rising timing of a line enable signal (EZi). In the timing chart shown in FIG. 11, CUP2 indicates the output state of the current line and CUP1=1 indicates that data is output and CUP1=0 indicates that data is not output. Furthermore, CUP1 indicates an output state of the next line and CUP=1 indicates that the next line is output and CUP1=0 indicates that the next line is not output.

a) A data path when the current line is output (CUP2=1) and the next line is output (CUP1=1) will be explained.

Image data (DZpi) and half-tone dot information data (DZai) input do not pass through the sub-scanning scale-down interpolation circuit 601 and main scanning scale-down interpolation circuit 602 but are written to either one of the line memory 1 or line memory 2 through the selector (SEL1). The data written one line before is read from the remaining one line memory. The write address corresponding to the line memory at this time is ERWA as shown in FIG. 12 and counted up in synchronization with the input image data block (CKVD). Furthermore, the read address is MRA and may or may not be counted up at an input image data clock (CKVD) according to the main scanning scaling ratio. In the case of no count up, a plurality of data pieces at the same address is read and therefore image scale-up processing is carried out.

The image data read from the line memory 1 or line memory 2 and half-tone dot information data are subjected to main scanning scale-up interpolation processing by the main scanning scale-up interpolation circuit 603, and output as image data (DZpo) and half-tone dot information data (DZao).

b) A data path when the current line is output (CUP2=1) and the next line is not output (CUP1=0) will be explained.

Image data (DZpi) and half-tone dot information data (DZai) input do not pass through the sub-scanning scale-down interpolation circuit 601 or the main scanning scale-down interpolation circuit 602 but are written to either one of the line memory 1 or line memory 2 through the selector (SEL1). The data written one line before is read from the remaining one line memory. The write address corresponding to the line memory at this time is ERWA as shown in FIG. 12 and counted up in synchronization with the input image data clock (CKVD). Furthermore, the read address is MRA and may or may not be counted up at the input image data clock (CKVD) according to the main scanning scaling ratio.

The image data and half-tone dot information data read from the line memory 1 or line memory 2 are subjected to main scanning scale-up interpolation processing by the main scanning scale-up interpolation circuit 603 and output as image data (DZpo) and half-tone dot information data (DZao).

c) A data path when the current line is not output (CUP2=0) and the next line is output (CUP1=1) will be explained.

Image data (DZpi) and half-tone dot information data (DZai) input are input to one side of the sub-scanning scale-down interpolation circuit 601. The image data and half-tone dot information data read from either one of the line memory 1 or line memory 2 under a control which will be described later is input to the other side of the sub-scanning scale-down interpolation circuit 601 through the selector (SEL5) and subjected to sub-scanning scale-down interpolation processing between both the image data and half-tone dot information data. The result of sub-scanning scale-down interpolation processing is written to either one of the line memory 1 or line memory 2 through the selector (SEL1) without passing through the main scanning scale-down interpolation circuit 602. The data written one line before is read from the remaining one line memory. The write address and read address corresponding to the line memory at this time are RWA as shown in FIG. 12 and counted up in synchronization with the input image data clock (CKVD).

The image data and half-tone dot information data read from the line memory 1 or line memory 2 are returned to the input section and input to the selector (SEL5). At this data path, neither image data (DZpo) nor half-tone dot information data (DZao) is output.

d) A data path when the current line is not output (CUP2=0) and the next line is not output (CUP1=0) will be explained. Data output occurs at the sub-scanning scale-down ratio<50% and does not exist in FIG. 11 and FIG. 12.

Image data (DZpi) and half-tone dot information data (DZai) input are input to one side of the sub-scanning scale-down interpolation circuit 601. The image data read from either one of the line memory 1 or line memory 2 under a control which will be described later is input to the other side of the sub-scanning scale-down interpolation circuit 601 through the selector (SEL5). Then, sub-scanning scale-down interpolation processing is carried out between both the image data and half-tone dot information data. The result of the sub-scanning scale-down interpolation processing is written to either one of the line memory 1 or line memory 2 through the selector (SEL1) without passing through the main scanning scale-down interpolation circuit 602. The data written one line before is read from the remaining one line memory. The write address and read address corresponding to the line memory at this time are ERWA and counted up in synchronization with the input image data clock (CKVD).

The image data and half-tone dot information data read from the line memory 1 or line memory 2 are input to the aforementioned SEL5. At this data path, neither the image data (DZpo) nor half-tone dot information data (DZao) is output.

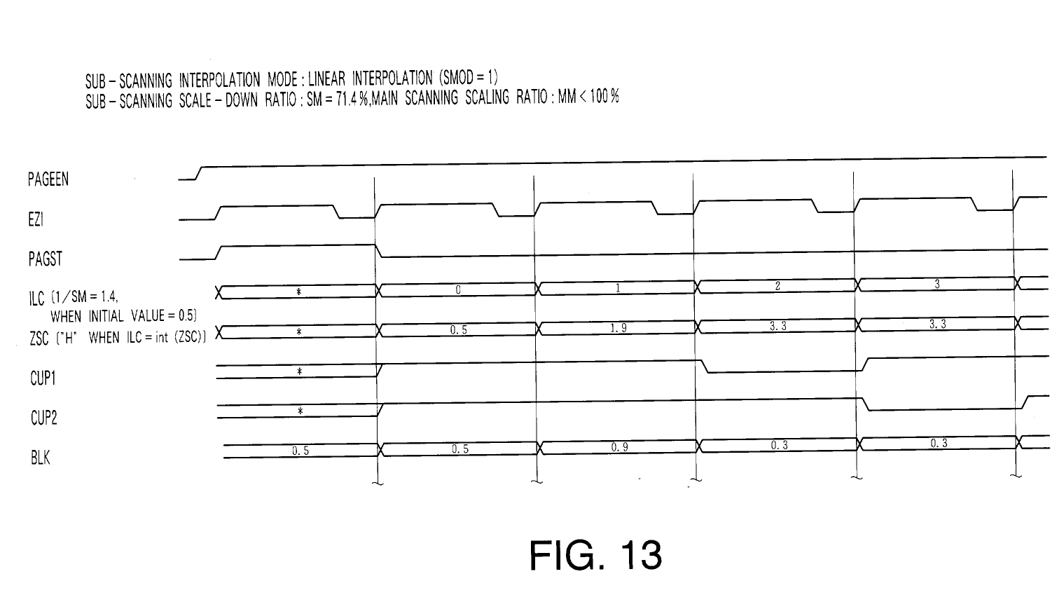

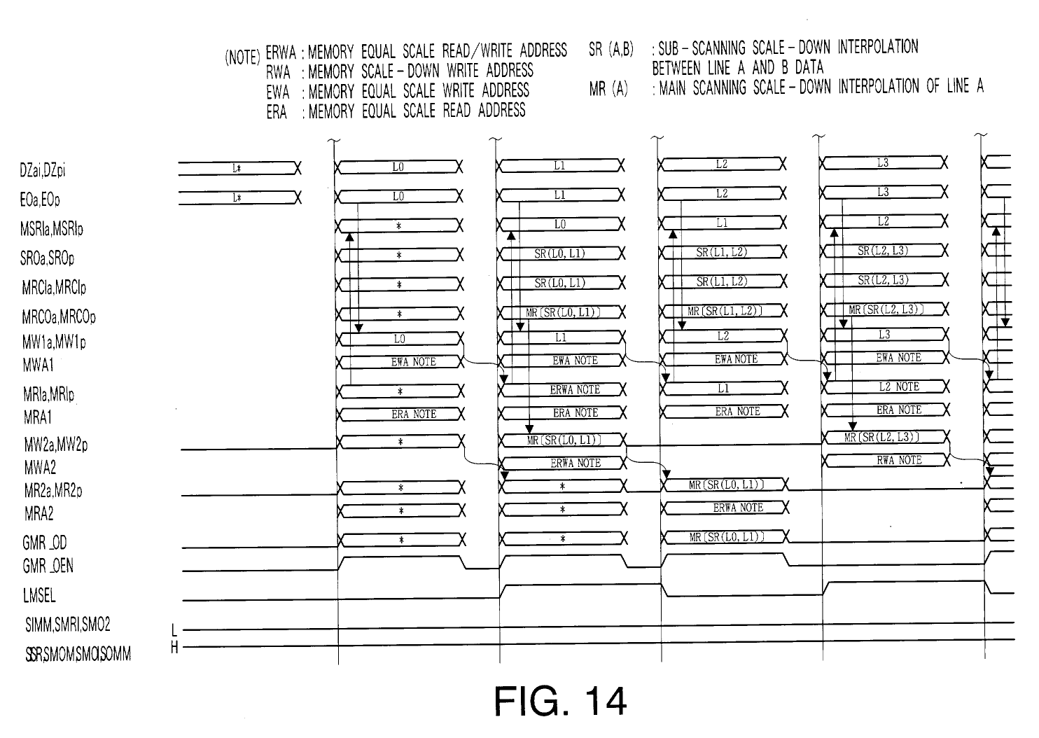

FIG. 13 and FIG. 14 show timing charts when the sub-scanning interpolation mode is linear interpolation (SMOD=1), the sub-scanning scale-down ratio is less than 100% (71.4% in the example) and the main scanning scale-down ratio is less than 100%.

The scaling control circuit 600 decides whether or not to output data from the scaling processing circuit according to the sub-scanning scale-down ratio at the rising timing of a line enable signal (EZi). In the timing chart shown in FIG. 13, when CUP2 which indicates the output state of the current line is 1, it indicates that data is output and CUP2=0 indicates that data is not output. In this sub-scanning interpolation mode, a data path is fixed irrespective of the logic of the CUP1 and 2 as shown below. The line memory 1 and line memory 2 perform as a dual port and can execute reading and writing simultaneously.

The image data (DZpi) and half-tone dot information data (DZai) input are input to the sub-scanning scale-down interpolation circuit 601 and at the same time written to the line memory 1 through the selectors (SEL1, 3). Data is read simultaneously through a dual port operation of the line memory 1. As shown in FIG. 14, the write address is EWA and the read address is ERA and these are counted up in synchronization with the input image data clock (CKVD) and controlled so that the read address always precedes, for example, as ERA=EWA+1.

The data read from the line memory 1 is data one line ahead and input to the sub-scanning scale-down interpolation circuit 601 through the selector (SEL5). The sub-scanning scale-down interpolation circuit 601 executes interpolation processing through a linear interpolation calculation. The result of the sub-scanning scale-down interpolation processing is input to the main scanning scale-down interpolation circuit 602 through the selector (SEL2) and main scanning scale-down interpolation processing is carried out. The result of the main scanning scale-down interpolation processing is written to the line memory 2 through the selector (SEL4).

Through the dual port operation of the line memory 2, the data written one line before is simultaneously read. The write address at this time is RWA and may or may not be counted up at an input image data clock (CKVD) according to the main scanning scale-down ratio. In the case of no count up, data is overwritten at the same address and the previously written data is deleted. Furthermore, the read address is ERWA and counted up in synchronization with the input image data clock (CKVD).

The image data and half-tone dot information data read from the line memory 2 are output as image data (DZpo) and half-tone dot information data (DZao) through the selector (SEL7) without passing through the main scanning scale-up interpolation circuit 603.

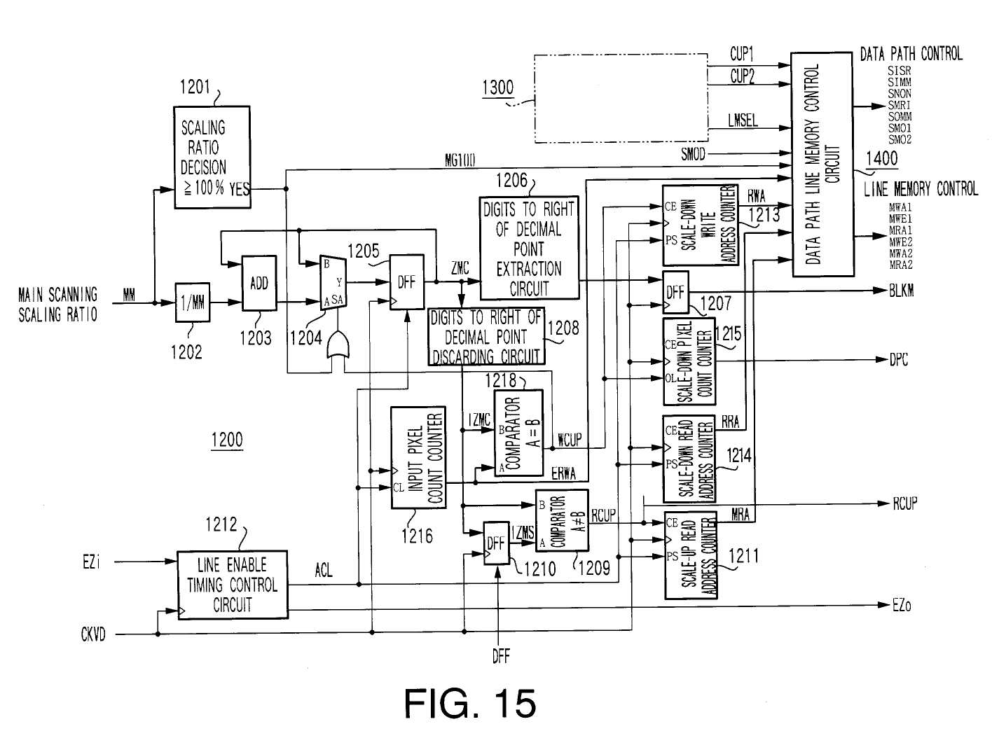

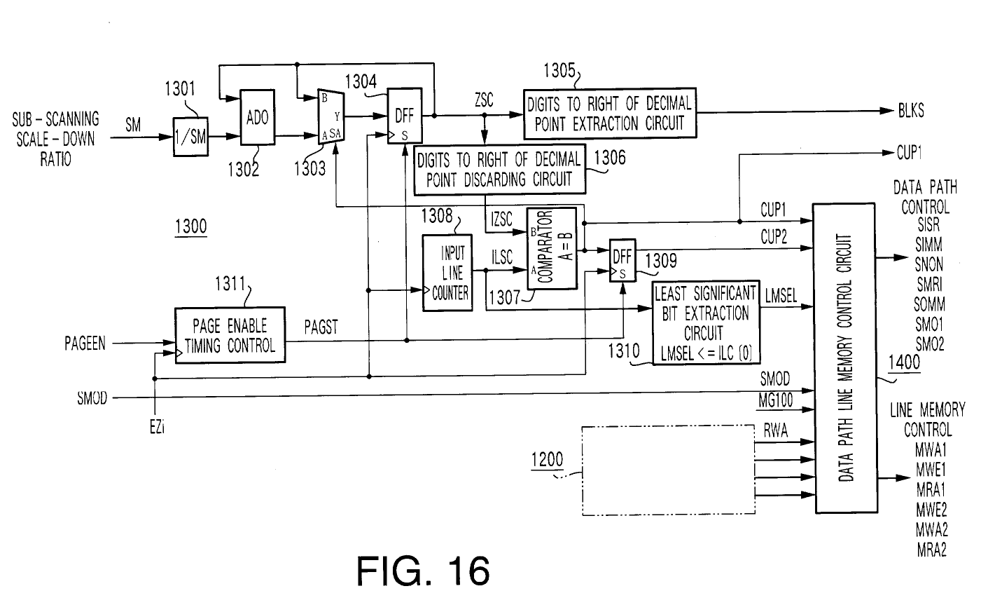

Then, the internal configuration and operation of the scaling control circuit 600 will be explained in detail. FIG. 15 and FIG. 16 illustrate the internal configuration of the scaling control circuit 600. FIG. 15 shows details of the configuration mainly involved in main scanning scaling (hereinafter referred to as “main scanning side block 1200”). FIG. 16 shows details of the configuration mainly involved in sub-scanning scaling (hereinafter referred to as “sub-scanning side block 1300”).

With reference to FIG. 15, the processing related to a main scanning scaling ratio setting will be explained. A scaling ratio decision circuit 1201 decides whether the main scanning scaling ratio is equal to or greater than or less than 100% depending on the input value of the main scanning scaling ratio (MM). This decision result is indicated by an MG100 signal.

(When main scanning scaling ratio is 100% or above) Considering that the MG100 signal is 1, the scale-up read address (MRA) and main scanning linear interpolation coefficient (BLKM) are generated through the following processing. First, the main scanning scaling ratio (MM) is input to a reciprocal calculation circuit 1202 to calculate a reciprocal (1 /MM) of the main scanning scaling ratio (MM) and the reciprocal (1 /MM) is input to an adding circuit 1203. The adding circuit 1203 adds up the reciprocal (1 /MM) and a cumulative count value (ZMC). The addition value is input to an FF circuit 1205 through a selector 1204 and output as the following cumulative count value (ZMC) in synchronization with an image clock (CKVD) from the FF circuit 1205.

The cumulative count value (ZMC) is returned to the adding circuit 1203 and at the same time input to a digits to the right of the decimal point extraction circuit 1206. The digits to the right of the decimal point extraction circuit 1206 outputs a decimal point and digits to the right of the decimal point of the cumulative count value (ZMC) to the FF circuit 1207 and the FF circuit 1207 outputs it as the main scanning linear interpolation coefficient (BLKM) in synchronization with an image clock (CKVD).

The cumulative count value (ZMC) is input to a digits to the right of the decimal point discarding circuit 1208. The digits to the right of the decimal point discarding circuit 1208 inputs a value (IZMC) obtained by discarding all digits to the right of the decimal point of the cumulative count value (ZMC) in a comparator 1209 and an FF circuit 1210. The comparator 1209 compares the value (IZMC) obtained by discarding all digits to the right of the decimal point of the cumulative count value (ZMC) with data (IZMS) obtained by synchronizing the data with the image clock (CKVD) using the FF circuit 1210 and shifting it by one clock, sets RCUP to 1 when IZMC IZMS and sets RCUP to 0 otherwise. RCUP is input to a scale-up read address counter 1211.

The scale-up read address counter 1211 receives a control signal from a line enable timing control circuit 1212. The scale-up read address counter 1211 is cleared at the start of a line enable signal (EZi) through the line enable timing control and a scale-up read address (MRA) is generated in synchronization with the image clock (CKVD) when RCUP is 1 or by incrementing the address value when there is no inversion.

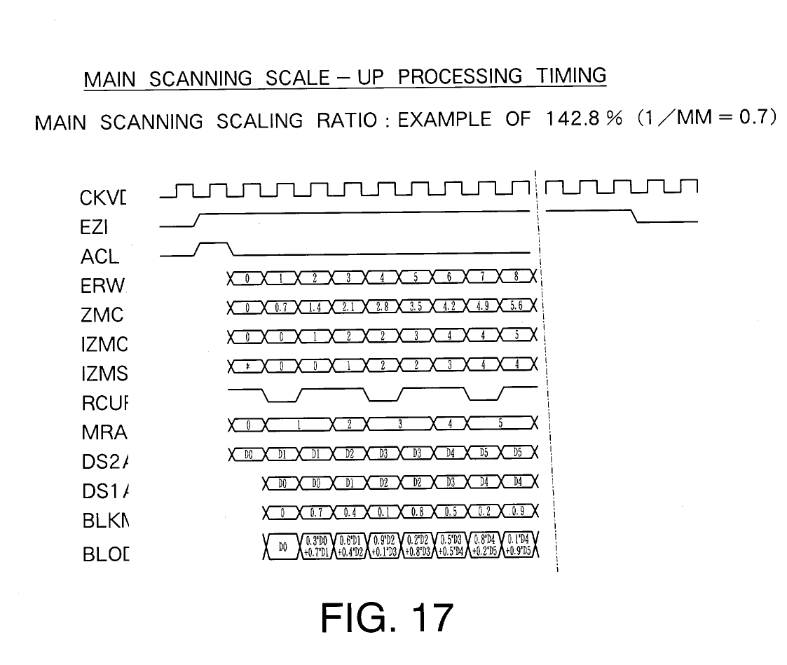

FIG. 17 shows a timing chart when the main scanning scaling ratio is 142.8%. As shown simultaneously, the read address (MRA) is incremented sequentially from a minimum value (=0) which is a preset address. It is incremented when RCUP is 0, while it is not incremented and the same address is maintained when RCUP is 0. At this time, a case of IZMC=IZMS occurs according to the main scanning scaling ratio (=142.8%) and a period during which RCUP is 0 occurs. During this period, even if a pixel clock is generated, the read address (MRA) is controlled so as to maintain the same value, and therefore data (D1, D3, D5) at the same address is repeatedly read from the line memory 1 or line memory 2. As a result, image data and half-tone dot information data read from the line memory 1 or line memory 2 under the scale-up read control become a data string scaled up in the main scanning direction.

Thus, when the main scanning scaling ratio is 100% or more, the scale-up read address counter 1211 may or may not count up the read address in synchronization with the input image data clock (CKVD) based on the status of RCUP generated according to the main scanning scaling ratio, and therefore if data is read from the line memory 1 or line memory 2 according to the read address (MRA), the image data and half-tone dot information data subjected to scaling processing as shown in FIG. 17 are output from the line memory 1 or line memory 2.

Then, the case where the main scanning scaling ratio is less than 100% will be explained. The scaling ratio decision circuit 1201 shown in FIG. 15 sets the MG100 signal to 0 when the main scanning scaling ratio is less than 100%.

When the MG100 signal is set to 0, the following processing will be carried out to generate scale-down write address (RWA) and scale-down pixel count value (DPC) and main scanning linear interpolation coefficient (BLKM).

According to the status of WCUP which will be described later, if WCUP=1, a reciprocal (1 /MM) of the main scanning scaling ratio (MM) is calculated by the reciprocal calculation circuit 1202 and added to a cumulative count value (ZMC) by the adding circuit 1203. The addition value is input to the FF circuit 1205 through the selector 1204 and output from there as the next cumulative count value (ZMC) in synchronization with the image clock (CKVD).

When WCUP=0, the cumulative count value (ZMC) is input to the FF circuit 1205 through the selector 1204 again and output from there as the next cumulative count value (ZMC) in synchronization with the image clock (CKVD).

The digits to the right of the decimal point extraction circuit 1206 outputs digits to the right of the decimal point of the cumulative count value (ZMC) as the main scanning linear interpolation coefficient (BLKM).

Furthermore, a comparator 1218 compares the value (IZMC) obtained by discarding all digits to the right of the decimal point of the cumulative count value (ZMC) with the input pixel count value (ERWA) obtained in synchronization with the image clock (CKVD) and sets WCUP to 1 when IZMC=ERWA and sets WCUP to 0 otherwise.

A scale-down write address counter 1213 is cleared at the start of a line enable signal (EZi) under the line enable timing control by the line enable timing control circuit 1212 and when WCUP=1, increments the address value in synchronization with the image clock (CKVD) and generates a scale-down write address (RWA).

A scale-down read address counter 1214 is cleared at the start of a line enable signal (EZi) under the line enable timing control by the line enable timing control circuit 1212 and increments the address value in synchronization with the image clock (CKVD) and generates a scale-down read address (RRA).

On the other hand, a scale-down pixel count counter 1215 clears the counter value when WCUP is 1 and counts up the scale-down pixel count value (DPC) in synchronization with the image clock (CKVD).

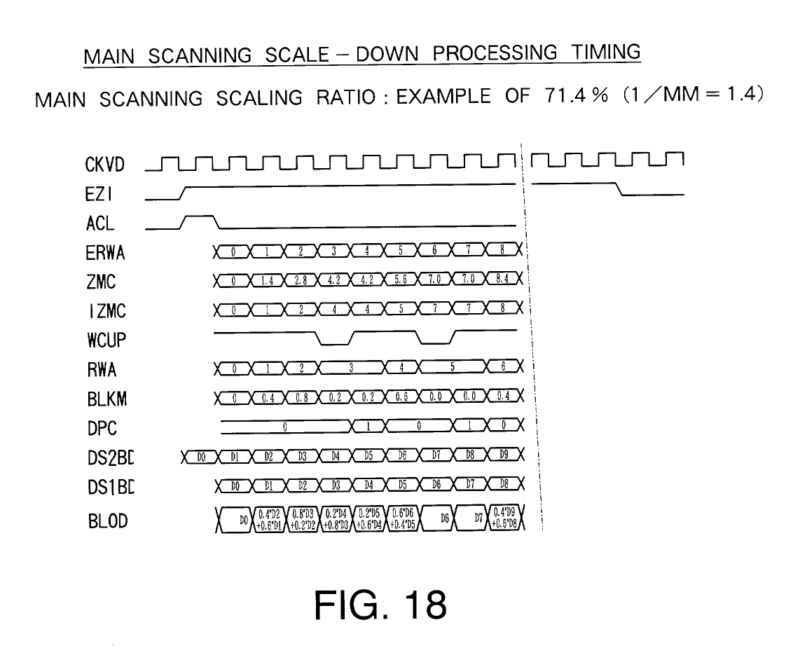

FIG. 18 shows a timing chart when the main scanning scaling ratio is 71.4%. When WCUP indicating the comparison result of a comparator 1218 is 0, the write address (RWA) generated by the scale-down write address counter 1213 does not change. Since the next data is overwritten at positions (3, 5) where the write address (RWA) has not changed, the data is scaled down in the main scanning direction.

Then, processing related to a setting of the sub-scanning scale-down ratio by the sub-scanning side block 1300 will be explained with reference to FIG. 16.

When CUP1 which will be described later is 1, a reciprocal (1 /SM) of the sub-scanning scaling ratio (SM) is calculated by a reciprocal calculation circuit 1301 and added to a cumulative count value (ZSC) by an adding circuit 1302. The addition value is input to the FF circuit 1304 through the selector 1303. The FF circuit 1304 outputs the addition value as the next cumulative count value (ZSC) in synchronization with the image clock (CKVD).

When CUP1 is 0, the cumulative count value (ZSC) is input to the FF circuit 1304 through the selector 1303. Then, the cumulative count value (ZSC) is output from the FF circuit 1304 as the next cumulative count value (ZSC) in synchronization with the image clock (CKVD). The cumulative count value (ZSC) is input to digits to the right of the decimal point extraction circuit 1305 and the digits to the right of the decimal point discarding circuit 1306.

The digits to the right of the decimal point extraction circuit 1305 extracts digits to the right of the decimal point of the cumulative count value (ZSC) and outputs it as a sub-scanning linear interpolation coefficient (BLKS).

Furthermore, digits to the right of the decimal point discarding circuit 1306 discards all digits to the right of the decimal point of the cumulative count value (ZSC) and inputs it to a comparator 1307. The comparator 1307 compares a value (IZSC) obtained by discarding all digits to the right of the decimal point of the cumulative count value (ZSC) with the count value (ILSC) of an input line counter 1308 that counts up in synchronization with the image enable input (EZi) and sets the CUP1 to 1 when IZSC=ILSC and sets it to 0 otherwise.

The CUP1 is input to an FF circuit 1309 and then shifted in synchronization with the image enable input (EZi) and output as CUP2. Furthermore, the output signal (ILSC) of the input line counter 1308 is input to a least significant bit extraction circuit 1310. The least significant bit extraction circuit 1310 extracts the least significant bit of ILSC and outputs it as LMSEL.

A data path line memory control circuit 1400 generates a data path control signal according to the truth table in FIG. 7 and generates a line memory control signal according to the truth table in FIG. 8.

In FIG. 7, what determines the data path control signal are statuses of a sub-scanning correction mode (SMOD), current line output enable (CUP2) and next line output enable (CUP1) signals.

The sub-scanning correction mode (SMOD) is a signal to select a method of scale-down processing in the sub-scanning direction and when SMOD=0, the sub-scanning correction mode is processing to reflect the data on the line determined to be tinned out through the scale-down processing by addition/averaging with the next line data, in the next line data and is applicable to both scale-up and scale-down as the main scanning scaling ratio.

When SMOD=1, the sub-scanning correction mode is processing to carry out a linear interpolation calculation according to line position information determined by the cumulative value of the reciprocal of the sub-scanning scale-down ratio and is applicable only to scale-down as the main scanning scaling ratio.

When current line output enable (CUP2) is 0, it means that the current line is a line to be thinned out and not output is generated and CUP2=1 indicates that the next line is the line to be continued and output is generated.

When next line output enable (CUP1) is 0, it means that the next line is a line to be thinned out and when CUP1=1 indicates that the next line is the line to be continued.

Furthermore, an LMSEL signal is a signal whereby 1 and 0 are switched round in synchronization with the line enable signal (EZi) and LMSEL=0 indicates that the line memory 1 is read and the line memory 2 is write. LMSEL=1 indicates that the line memory 1 is write and the line memory 2 is read.

In FIG. 8, what determines the line memory control signal are statuses of a sub-scanning correction mode (SMOD), current line output enable (CUP2), next line output enable (CUP1) signals, main scanning scaling ratio and the aforementioned LMSEL signal.

When the sub-scanning correction mode (SMOD) is 0, both the line memory 1 and line memory 2 perform single port operations and a read state or write state is set for each line according to the aforementioned LMSEL signal.

When the main scanning scaling ratio is 100% or more, if the current line output enable (CUP2) is 1 (output is generated), the write address is the address (ERWA) of the input pixel count counter 1216 in FIG. 15 and the read address is the scale-up read address (MRA) of FIG. 15.

When the current line output enable (CUP2) is 0 (no output), both the read address and write address become the address (ERWA) of the input pixel count counter 1216 in FIG. 15.

Furthermore, when the main scanning scaling ratio is less than 100%, in the case of the current line output disable (CUP2=0) and next line output enable (CUP1=1), the write address is the scale-down write address (RWA) in FIG. 15 and the read address is the address (ERWA) of the input pixel count counter in FIG. 15.

In the case of the current line output enable (CUP2=1) and next line output enable (CUP1=1), the write address is the scale-down write address (RWA) in FIG. 15 and the read address is the address (RRA) of the scale-down read address counter 1214 in FIG. 15.

In the case of the current line output disable (CUP=0) and next line output disable (CUP1=0), both the read address and write address are the address (ERWA) of the input pixel count counter 1216 in FIG. 15.

In the case of the current line output enable (CUP2=1) and next line output disable (CUP1=0), the read address is the address (RRA) of the scale-down read address counter 1214 in FIG. 15 and the write address is the address (ERWA) of the input pixel count counter 1216 in FIG. 15.

Then, when the sub-scanning correction mode (SMOD) is 1, both the line memory 1 and line memory 2 perform a dual port operation and the write address of the line memory 1 is an equal scale write address (EWA) which has same value as the address (ERWA) of the input pixel count counter 1216 in FIG. 15 and the read address is an equal scale read address (ERA) which is the address (ERWA) of the input pixel count counter 1216 in FIG. 15 plus 1.

The read address of the line memory 2 is the address (ERWA) of the input pixel count counter 1216 in FIG. 15 and the write address is the scale-down write address (RWA) in FIG. 15.

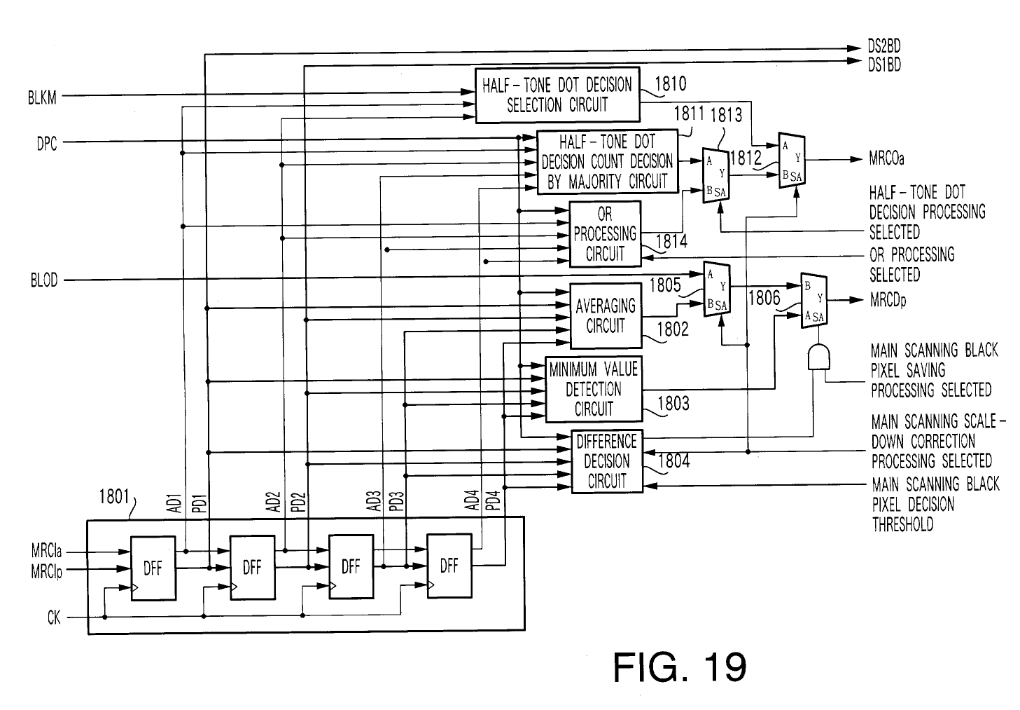

Then, the main scanning scale-down interpolation circuit 602 will be explained. FIG. 19 is a block diagram of the main scanning scale-down interpolation circuit 602. Image data (MRCIp) and half-tone dot information data (MRCIa) input to the main scanning scale-down interpolation circuit 602 are selected by a selector (SEL2). The image data (MRCIp) and half-tone dot information data (MRCIa) are input to a first FF circuit that makes up a tapped shift register 1801. The tapped shift register 1801 shifts the input image data (MRCIp) and half-tone dot information data (MRCIa) in synchronization with an image clock (CK) and generates image data (PD1 to PD4) and half-tone dot decision data (AD1 to AD4). It also outputs PD1 to an external linear interpolator as DS2BD and outputs PD2 as DS1BD.

Image data (PD1, PD2) output from the first and second FF circuits are output to the linear interpolation calculator 604 as DS2BD (PD1) and DS1BD (PD2).

Furthermore, an average value circuit 1802 is fed DPC which is a signal indicating the image data (PD1 to PD4) and pixel thinning-out count and calculates and outputs an average value of the image data (PD1 to PD4). A minimum value detection circuit 1803 selects and outputs a minimum value from among the image data (PD1 to PD4). A difference decision circuit 1804 calculates a difference of the image data (PD1 to PD4) and outputs the difference value. The minimum value detection circuit 1803 and difference decision circuit 1804 are provided to save black thin lines. The output of the average value circuit 1802 is output as correction image output (MRCOp) through selectors 1805 and 1806. Conditions for deciding the selection operation of the selectors 1805 and 1806 will be explained in detail below.

The correction image output (MRCOp) selects image processing according to the following conditions.

When linear interpolation processing is selected as the main scanning scale-down correction processing and saving processing disable is selected as the main scanning black pixel saving processing, output data BLOD of an external linear interpolator is output as correction image output (MRCOp).

When linear interpolation processing is selected as the main scanning scale-down correction processing and saving processing enable is selected as the main scanning black pixel saving processing, if:

|PD1−PD2|<main scanning black pixel decision threshold

according to the values of PD1 and PD2, the output data BLOD of the external linear interpolator is output as correction image output (MRCOp). If:

|PD1−PD2|≧main scanning black pixel decision threshold

the minimum value detection circuit 1803 compares PD1 and PD2 and outputs the one with a lower level as the correction image output (MRCOp).

When averaging interpolation processing is selected as the main scanning scale-down correction processing and saving processing disable is selected as the main scanning black pixel saving processing, an average value of the image data (PD1 to PD4) is calculated by the average value circuit 1802 according to the value of DPC and the output data BLOD of the external linear interpolator is output as correction image output (MRCOp).

When DPC=0, BLOD=PD1

When DPC=1, BLOD=(PD1+PD2)/2

When DPC=2, BLOD=(PD1+PD2+PD3)/3

When DPC=3, BLOD=(PD1+PD2+PD3PD4)/4

When averaging interpolation processing is selected as the main scanning scale-down correction processing and saving processing enable is selected as the main scanning black pixel saving processing, data is output as correction image output (MRCOp) based on the difference from neighboring pixels between the PDC value and image data (PD1 to PD4) and main scanning black pixel decision threshold as follows:

When DPC=0, BLOD=PD1

When DPC=1, if:

|PD1−PD2|<main scanning black pixel decision threshold

BLOD=(PD1+PD2)/2, and if:

|PD1-PD2|≧main scanning black pixel decision threshold

BLOD=min(PD1, PD2)

where, min(A,B,C . . . ) is a minimum value among A, B, C . . .

When DPC=2, if:

|PD1−PD2|≧main scanning black pixel decision threshold or

|PD2−PD3|≧main scanning black pixel decision threshold

BLOD=min(PD1, PD2, PD3)

Otherwise, BLOD=(PD1+PD2+PD3)/3

When DPC=3, if:

|PD1−PD2|≧main scanning black pixel decision threshold or

|PD2−PD3|≧main scanning black pixel decision threshold or

|PD3−PD4|≧main scanning black pixel decision threshold

BLOD=min(PD1, PD2, PD3, PD4)

Otherwise, BLOD=(PD1+PD2+PD3+PD4)/4

Furthermore, the above-described main scanning scale-down interpolation circuit 602 is provided with a half-tone dot decision selection circuit 1810, a half-tone dot decision count decision by majority circuit 1811 and an OR processing circuit 1814 to propagate the half-tone dot information data to the image processing block, etc., in the subsequent section. The half-tone dot decision selection circuit 1810 is fed the half-tone dot information data (AD1, AD2) output from the first and second FF circuits of the shift register 1801 and further fed the main scanning linear interpolation coefficient (BLKM) output from the scaling control circuit 600. Furthermore, the half-tone dot decision count decision by majority circuit 1811 is fed half-tone dot information data (AD1, AD2, AD3, AD4) output from each FF circuit of the shift register 1801 and is further fed the scale-down pixel count value (DPC) from the scaling control circuit 600. The OR processing circuit 1814 is fed the same data as that of the half-tone dot decision count decision by majority circuit 1811. The outputs of the half-tone dot decision count decision by majority circuit 1811 and OR processing circuit 1814 are selected through the selector 1813 and the output of the selector 1813 and output of the half-tone dot decision selection circuit 1810 are output to the subsequent section as half-tone dot decision image output (MRCOa) through the selector 1812. The condition for selecting image processing by half-tone dot decision image output (MRCOa) will be explained below.

Half-tone dot decision image output (MRCOa) selects image processing according to the following condition:

When linear interpolation processing is selected as main scanning scale-down correction processing, the following selection is made using the half-tone dot decision selection circuit 1810:

When BLKM≦0.5

MRCOa=AD1

When BLKM>0.5

MRCOa=AD2

When averaging interpolation processing is selected as main scanning scale-down correction processing and half-tone dot decision by majority is selected as half-tone dot decision processing, the following selection is made using the half-tone dot decision count decision by majority circuit 1811:

When DPC=0, MRCOa=AD1.

When DPC=1, if at least one of AD1 and AD2 is decided to be a half-tone dot, MRCOa is decided to be a half-tone dot.

When DPC=2, if at least two of AD1, AD2 and AD3 are decided to be half-tone dots, MRCOa is decided to be a half-tone dot.

When DPC=3, if at least three of AD1, AD2, AD3 and AD4 are decided to be half-tone dots, MRCOa is decided to be a half-tone dot.

When averaging interpolation processing is selected as main scanning scale-down correction processing and OR processing is selected as half-tone dot decision processing, the following selection is made using the OR processing circuit 1814:

When simple OR is selected as OR processing, the procedure is as follows:

When DPC=0, MRCOa is decided to be a half-tone dot on condition that AD1 is decided to be a half-tone dot.

When DPC=1, MRCOa is decided to be a half-tone dot on condition that either one of AD1 or AD2 is decided to be a half-tone dot.

When DPC=2, MRCOa is decided to be a half-tone dot on condition that any one of AD1, AD2 or AD3 is decided to be a half-tone dot.

When DPC=3, if any one of AD1, AD2, AD3 or AD4 is decided to be a half-tone dot, MRCOa is decided to be a half-tone dot.

On the other hand, when neighboring OR is selected as OR processing, MRCOa is decided to be a half-tone dot on condition that either one of AD1 or AD2 is decided to be a half-tone dot irrespective of the value of DPC.

Next, the main scanning scale-up interpolation circuit 603 will be explained.

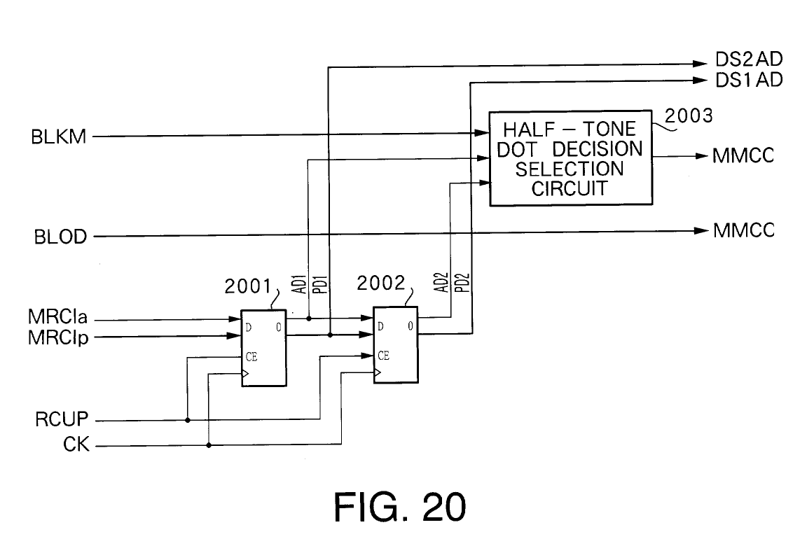

FIG. 20 illustrates a circuit configuration of the main scanning scale-up interpolation circuit 603. As shown in the same figure, the main scanning scale-up interpolation circuit 603 is constructed of a shift register made up of FF circuits 2001 and 2002 connected in series and a half-tone dot decision selection circuit 2003. Image data (MRCIp) and half-tone dot information data (MRCIa) are input to a data input terminal of the FF circuit 2001 and an RCUP signal is input to its CE terminal. Half-tone dot information data (AD1, AD2) output from the FF circuits 2001 and 2002 is input to the half-tone dot decision selection circuit 2003 and image data (PD1, PD2) output from the FF circuits 2001 and 2002 is output to a linear interpolation calculator 604 with PD1 as DS2AD and PD2 as DS1AD.

In the main scanning scale-up interpolation circuit 603, the image data (MRCIp) and half-tone dot information data (MRCIa) input to the shift register are shifted in synchronization with an image clock (CK) when the RCUP signal is “H” to generate the image data (PD1 and PD2) and half-tone dot decision data (AD1 and AD2). Output data (BLOD) from the external linear interpolation calculator 604 is input and output as main scanning scale-up interpolation image data (MMCOp).

The half-tone dot decision output (MMCOa) is generated using the half-tone dot decision selection circuit 2003 as follows:

When BLKM≦0.5,

MRCOa=AD1

When BLKM>0.5,

MRCOa=AD2

Then, the sub-scanning scale-down interpolation circuit 601 will be explained.

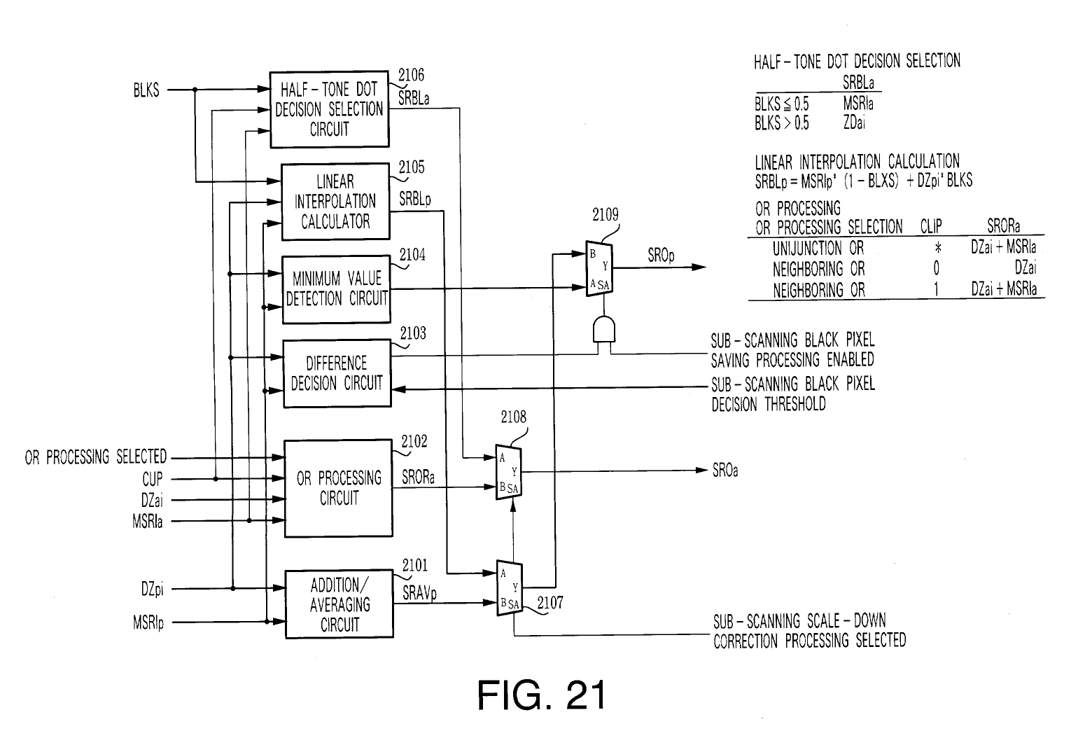

FIG. 21 illustrates a circuit configuration of the sub-scanning scale-down interpolation circuit 601. As shown in the same figure, when the sub-scanning scale-down correction processing selection function is averaging interpolation processing and the sub-scanning black pixel saving processing is disabled, addition/averaging data (SRAVP) of two image data inputs (DZpi, MSRIp) calculated by the addition/averaging circuit 2101 is output as sub-scanning scale-down interpolation output data (SROp) through the selectors 2107 and 2109. The sub-scanning scale-down interpolation image output data (SROp) at this time is:

SROp=(DZpi+MSRIp)/2

Furthermore, when the sub-scanning scale-down correction processing selection function is averaging interpolation processing and the sub-scanning black pixel saving processing is enabled, the difference decision circuit 2103 compares |DZpi-MSRIp| with a sub-scanning black pixel decision threshold, and if |DZpi-MSRIp|<sub-scanning black pixel decision threshold, addition/averaging data (SRAVP) of two image data inputs (DZpi, MSRIp) is output as sub-scanning scale-down interpolation output data (SROp). The sub-scanning scale-down interpolation image output data (SROp) at this time is:

SROp=(DZpi+MSRIp)/2

On the other hand, if |DZpi-MSRIp|≧sub-scanning black pixel decision threshold, the smaller one of the two image data inputs (DZpi, MSRIp) detected by the minimum value detection circuit 2104 is output. The sub-scanning scale-down interpolation image output data (SROp) at this time is:

SROp=min(DZpi, MSRIp)

Furthermore, when the sub-scanning scale-down correction processing selection function is linear interpolation processing and the sub-scanning black pixel saving processing is disabled, the linear interpolation calculator 2105 carries out a linear interpolation calculation on the two image data inputs (DZpi, MSRIp) and linear interpolation coefficient (BLKS) given by the scaling control circuit 600 and outputs the calculation result as sub-scanning scale-down interpolation image output data (SROp).

Here, the linear interpolation calculator 2105 calculates sub-scanning scale-down interpolation output data (SROp) according to the following mathematical expression:

SROp=MSRIp×(1-BLKS)+DZpi×BLKS

Furthermore, when the sub-scanning scale-down correction processing selection function is linear interpolation processing and the sub-scanning black pixel saving processing is enabled, the outputs of the linear interpolation calculator 2105, minimum value detection circuit 2104 and difference decision circuit 2103 are selected and output as follows:

When |DZpi-MSRIp|<sub-scanning black pixel decision threshold,

SROp=MSRIp×(1-BLKS)+DZpi×BLKS

When |DZpi-MSRIp|≧sub-scanning black pixel decision threshold,

SROp=min (DZpi,MSRIp)

On the other hand, the half-tone dot decision correction output (SROa) is selected as follows:

When the sub-scanning scale-down correction processing selection function is averaging interpolation processing, the half-tone dot decision correction output is decided from the two half-tone dot decision data inputs (DZai, MSRIa), the output of the OR processing function selection circuit 2102 and the control signal (CUP) from the scaling control circuit 600 as follows:

When simple OR is selected as the OR processing, the half-tone dot decision correction output (SROa) is decided to be a half-tone dot when either one of DZai or MSRIa is decided to be a half-tone dot. The half-tone dot decision correction output (SROa) at this time is:

SROa=DZai+MSRIa

Furthermore, when neighboring OR is selected as the OR processing and the next line is not output when the control signal (CUP1) is 0, (SROa) is decided to be a half-tone dot when DZai is decided to be a half-tone dot. The half-tone dot decision correction output (SROa) at this time is:

SROa=Dzai

Furthermore, when neighboring OR is selected as the OR processing and the next line is output when the control signal (CUP1) is 1, (SROa) is decided to be a half-tone dot when either one of DZai or MSRIa is decided to be a half-tone dot. The half-tone dot decision correction output (SROa) at this time is:

SROa=DZai+MSRIa

On the other hand, when the sub-scanning scale-down correction processing selection function is linear interpolation processing, a decision is made using the two half-tone dot decision data inputs (DZai, MSRIa) and linear interpolation coefficient (BLKS) as follows:

When BLKS≦0.5, a decision is made as:

SROa=MSRIa

When BLKS>0.5, a decision is made as:

SROa=DZai

As shown above, according to the scaling circuit 104, in the case of scale-up, scaled-up half-tone dot decision information is decided based on the relationship between the position of the pixel output and half-tone dot decision information before and after the pixel position and in the case of scale-down, the scaled-down half-tone dot decision information is decided based on a decision by majority of half-tone dot decision information within the input pixel range corresponding one pixel output or under an OR condition, and therefore it is possible to transmit the half-tone dot decision information to the next block even if scaling processing is applied.

Then, the configuration and operation of the image zoning processing circuit 115 will be explained in detail.

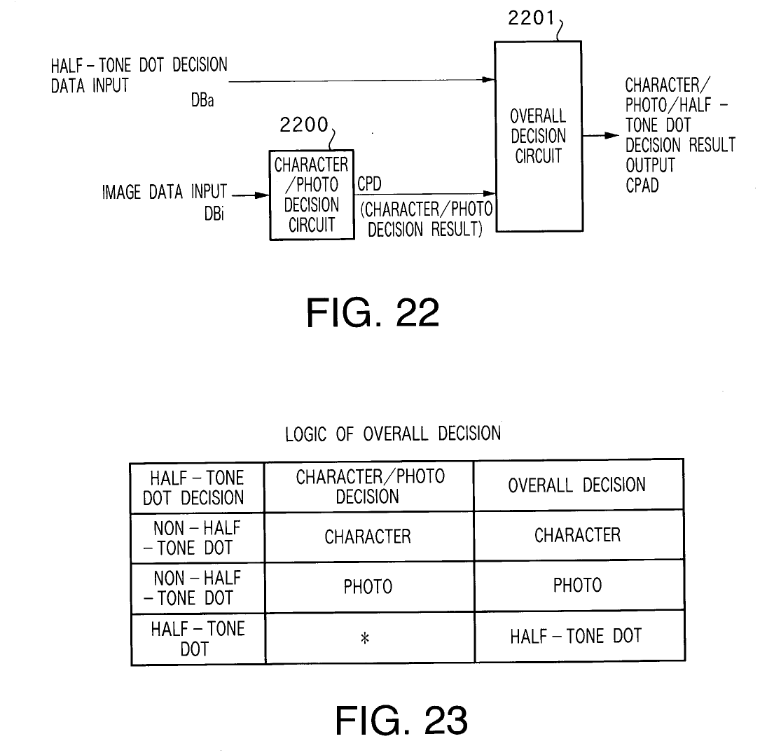

FIG. 22 is a block diagram of the character/photo/half-tone dot decision circuit 116. As shown in the same figure, the character/photo/half-tone dot decision circuit 116 inputs image data (DBi) entered to a character/photo decision circuit 2200. The character/photo decision circuit 2200 decides whether the data is a photo or character from characteristic amounts such as variation from neighboring pixels and spatial frequency distribution, and outputs a character/photo decision result (CPD).

On the other hand, the half-tone dot decision data input in synchronization with the above-described image data (DBi) and the character/photo decision result (CPD) are input to an overall decision circuit 2201. The overall decision circuit 2201 decides whether the data is a character, photo or half-tone dot according to the decision logic shown in FIG. 23 and outputs the character/photo/half-tone dot decision result (CPAD).

When the half-tone dot decision data is a half-tone dot, the character/photo/half-tone dot decision results in a half-tone dot irrespective of the character/photo decision result.

When the half-tone dot decision data is not a half-tone dot, if the character/photo decision result is a character, the character/photo/half-tone dot decision results in a character.

When the character/photo decision result is a photo, the character/photo/half-tone dot decision results in a photo.

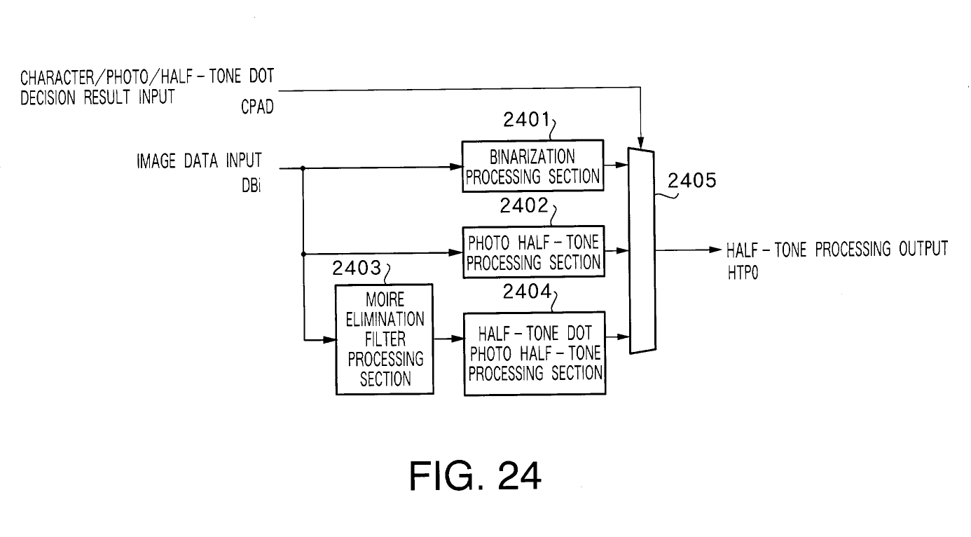

FIG. 24 is a block diagram of the character/photo/half-tone dot correspondence half-tone processing circuit 117. As shown in the same figure, the character/photo/half-tone dot correspondence half-tone processing circuit 117 is fed the character/photo/half-tone dot decision result (CPAD) from the character/photo/half-tone dot decision circuit 116 and executes the following image processing on the image data (DBi) to be input from the image processing block of the preceding section according to the character/photo/half-tone dot decision result input.

When the character/photo/half-tone dot decision results in a character, a binarization processing section 2401 compares it with a predetermined threshold and outputs the binarization processing result from a selector 2405 as a half-tone processing result (HTPo).

When the character/photo/half-tone dot decision results in a photo, a photo half-tone processing section 2402 carries out half-tone processing such as screen processing with excellent gradation expression and error spreading processing and outputs the processing result from the selector 2405 as a half-tone processing result (HTPo).

When the character/photo/half-tone dot decision results in a half-tone dot, a moiré elimination filter processing section 2403 carries out moiré elimination filter processing, then a half-tone dot photo half-tone processing section 2404 carries out half-tone processing such as error spreading processing which is suited to half-tone dots and unlikely to cause moiré, etc., and outputs the processing result from the selector 2405 as a half-tone processing result (HTPo).

(Embodiment 2)

Then, an image signal processing apparatus according to Embodiment 2 of the present invention will be explained. The image signal processing apparatus according to Embodiment 2 is an example of carrying out various kinds of image processing, then image zoning processing and applying multi-value recording processing suited to the image and comprising image compression of a multi-value image and an image storage memory at some midpoint.

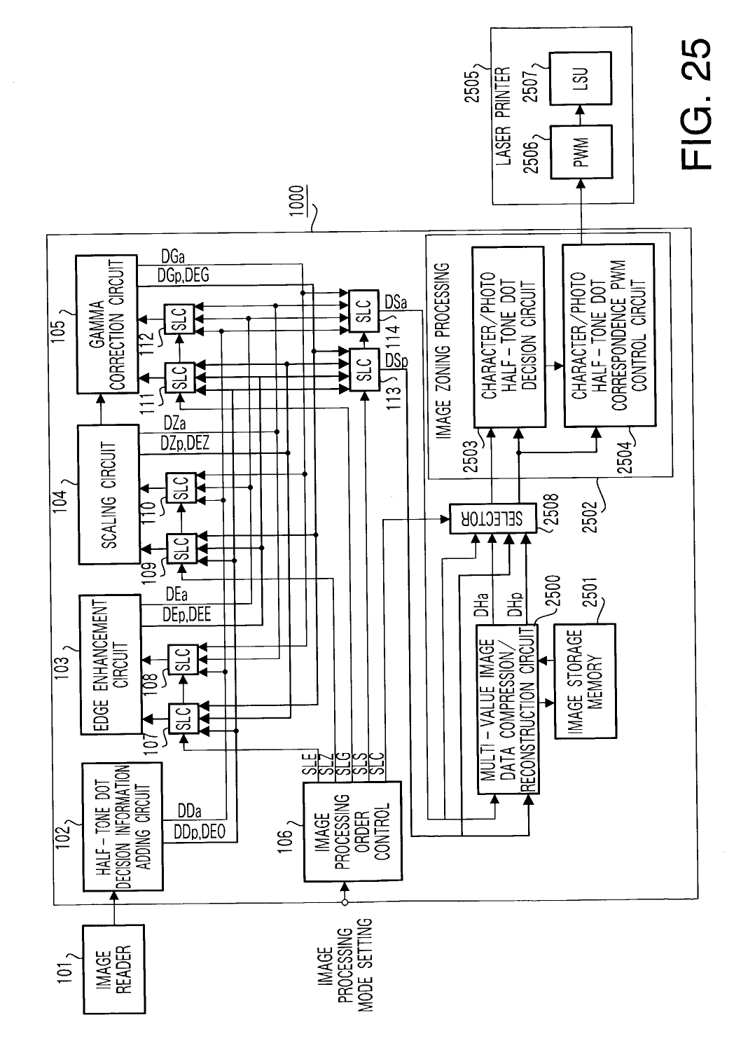

FIG. 25 is an overall block diagram of the image signal processing apparatus according to Embodiment 2. The block configuration that carries out image processing in an arbitrary image processing order adopts the same configuration as that of aforementioned Embodiment 1. The half-tone dot information data (Dsa) and image data (DSp) subjected to the image processing in the arbitrary image processing order is input to a multi-value image data compression/reconstruction circuit 2500, the multi-value image data and half-tone dot information data are compressed together and stored in an image storage memory 2501.

Furthermore, when the image data stored in an image storage memory 2501 is recorded, the corresponding data is read from the image storage memory 2501, half-tone dot information data (DHa) and image data (DHp) are reconstructed by the multi-value image data compression/reconstruction circuit 2500 and input to a character/photo/half-tone dot decision circuit 2503 of an image zoning processing circuit 2502. The character/photo/half-tone dot decision circuit 2503 decides whether each pixel is a character, photo or half-tone dot photo. The method of decision at the character/photo/half-tone dot decision circuit 2503 used is the same as the method of decision according to Embodiment 1. According to the decision result, PWM data and PWM control signal corresponding to the character/photo/half-tone dot are generated by a character/photo/half-tone dot correspondence PWM control circuit 2504.

More specifically, image data processing is applied directly to the character decision section and PWM control is performed as 1-pixel PWM control. Furthermore, the image data processing applied to the photo decision section is 2-pixel averaging processing using even and odd pixels and PWM control is performed as 2-pixel cycle PWM control. Furthermore, the image data processing applied to the half-tone dot photo section is 2-pixel averaging processing using even and odd pixels after moiré elimination filter processing and PWM control is performed as 2-pixel cycle PWM control.

The image data and PWM control signal obtained through the above-described processing are input to a laser printer 2505.

A signal processing section of the laser printer 2505 includes a PWM (pulse width modulator) 2506 and an LSU (laser scan unit) 2507 and the image data and PWM control signal input to the PWM 2506 are converted to a pulse signal and the pulse signal is converted to a laser beam by the LSU 2507, subjected to recording/scanning on a photosensitive medium and in this way allowed to record multi-values.

Selecting a PWM pulse cycle and data processing according to the character/photo/half-tone dot decision sections makes it possible to obtain a recording image with high resolution and high sharpness for the character section, a high gradation characteristic for the photo section and a high gradation characteristic free of moiré for the half-tone dot section.

By the way, when memory storage of multi-value image data is not necessary, the image processing order control circuit 106 can also change a selector 2508 to directly input half-tone dot information data (Dsa) subjected to image processing and image data (DSp) to an image zoning processing circuit 2502.

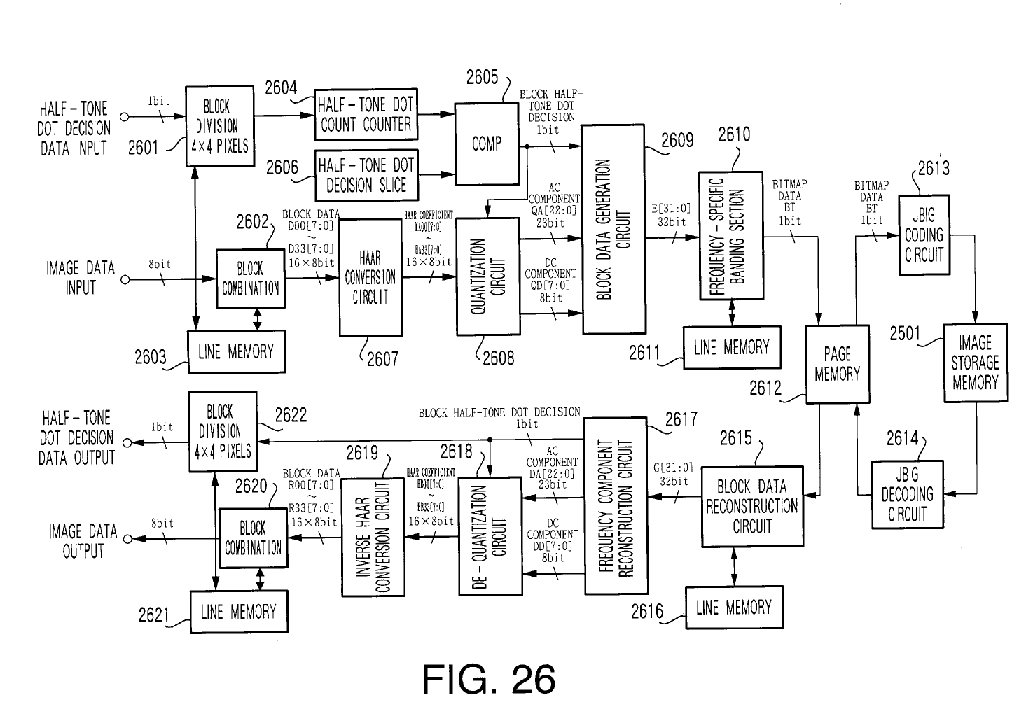

FIG. 26 shows a configuration of the multi-value image data compression/reconstruction circuit 2500. As shown in the same figure, half-tone dot decision data and image data are input to the irrespective block division circuits 2601 and 2602. The block division circuits 2601 and 2602 divide input data into 4×4 pixel blocks using a line memory 2603.

A half-tone dot count counter 2604 counts a half-tone dot decision count inside the half-tone dot decision data divided into 4×4 pixel blocks. A comparator 2605 compares the half-tone dot count value and a predetermined half-tone dot decision slice and if the half-tone dot count value is greater, the comparator 2605 decides the block as a half-tone dot block and sets a block half-tone dot decision signal in a half-tone dot decision state. By the way, the half-tone dot decision slice is set from a half-tone dot decision slice setting section 2606.

Furthermore, the image data divided into 4×4 pixel blocks is subjected to a HAAR conversion by a HAAR conversion circuit 2607. The HAAR conversion is a kind of orthogonal conversion and converts the image data to a HAAR coefficient. The HAAR coefficient is quantized according to a predetermined quantization table at a quantization circuit 2608. At this time, inside the quantization block, quantization processing for a half-tone dot decision and quantization processing for non-half-tone dot decision are switched round according to the block half-tone dot decision signal.

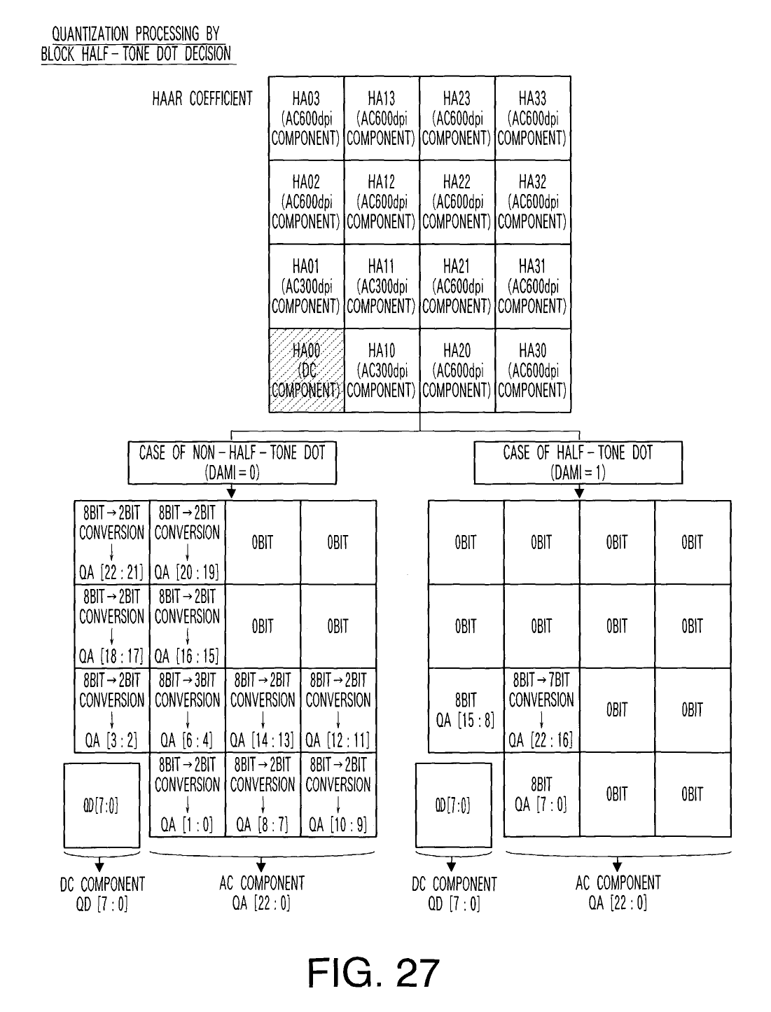

FIG. 27 shows an example of quantization processing using a block half-tone dot decision. As shown in the same figure, when the block half-tone dot decision results in a non-half-tone dot, bits are assigned up to the HAAR coefficient of a high frequency component. On the other hand, in the case of a half-tone dot decision, bits of the HAAR coefficient of the high frequency component are rounded down and the remaining bits are assigned in such a way that the number of low frequency bits is increased.

This allows the half-tone dot image section to cut the high frequency component which may cause moiré and also delete a quantization error of the low frequency component, making it possible to reconstruct a satisfactory half-tone dot image. On the other hand, the high frequency component of the non-half-tone dot section (character section, photo section) is not cut, and therefore an image with high resolution can be reconstructed.

A DC component 8 bits, AC component 23 bits and block half-tone dot decision signal 1 bit resulting from quantization are organized into 32-bit unit block data by a block data generation section 2609 and written into a line memory 2611 through a frequency-specific banding section 2610.

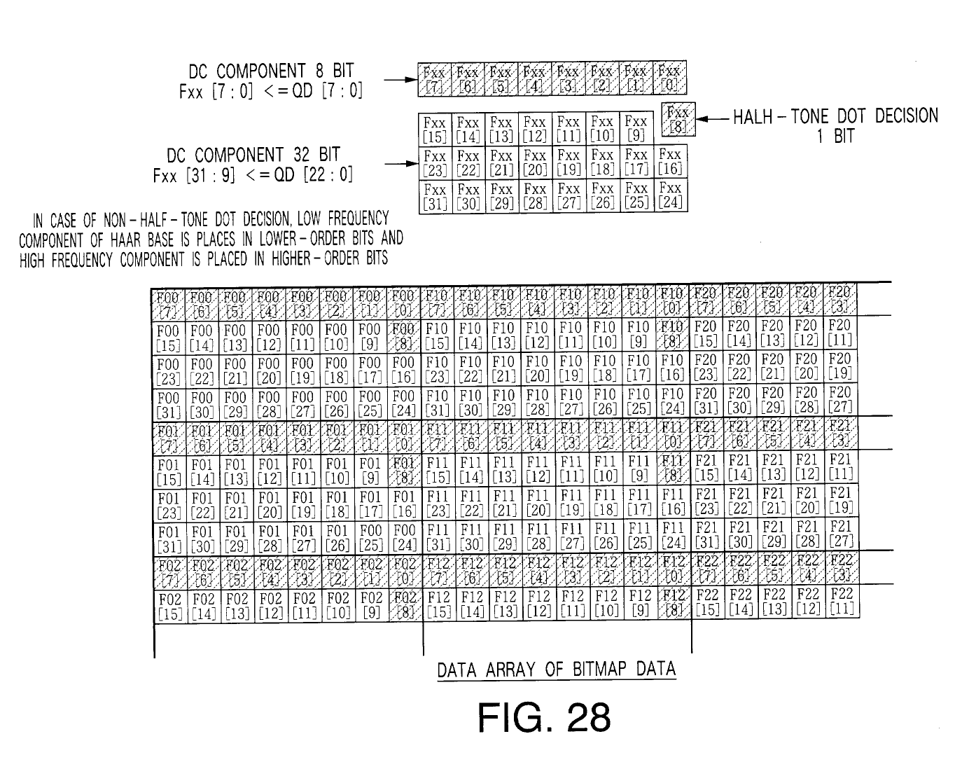

A bitmap data layout of FIG. 28 shows a data array on the line memory 2611 at this time. According to this embodiment, as shown in the same figure, the half-tone dot decision signal 1 bit is located near the AC low frequency component taking into account a scale-down ratio of JBIG coding in the subsequent section.

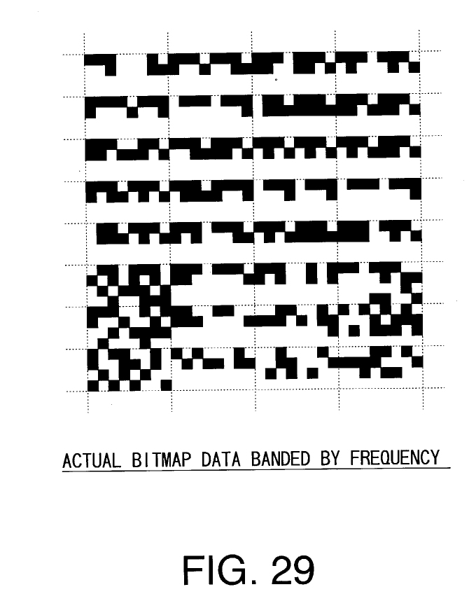

The frequency-specific banding section 2610 reads data from the line memory 2611 for each line in the horizontal direction of FIG. 28. As a result, a DC component adjacent to each block is read as one continuous band and then the AC low frequency component and half-tone dot decision signal 1 bit are read as one continuous band, then an AC intermediate frequency component and high frequency component are read as one band data piece one by one. The image data actually banded is shown in FIG. 29. The image data banded in this way is stored in a page memory 2612 and when it is stored in the image storage memory 2501, a JBIG coding circuit 2613 further compresses it to data and stores it in the image storage memory 2501.

Then, when the image data stored in the image storage memory 2501 is reconstructed, bitmap data is reconstructed on the page memory 2612 using the JBIG decoding circuit 2614.

Then, a block data reconstruction circuit 2615 extracts 1-block (32-bit) data necessary for decoding from the bitmap data on the page memory 2612 and reconstructs the block data using a line memory 2616.

A frequency component reconstruction circuit 2617 reconstructs a DC component signal DD[7:0] and AC component signal DA[22:0] from the 1-block data and a half-tone dot decision signal 1 bit.

The DC component signal DD[7:0] and AC component signal DA[22:0] are converted to HAAR coefficients (HB00-[7:00] to HB33[7:0] by a de-quantization circuit 2618 and furthermore the image block data (R00[7:0] to R33[7:0]) is reconstructed by an inverse HAAR conversion circuit 2619. Finally, the image block data is converted to raster data through a line memory 2621 and the image data is output.

On the other hand, the same value as the half-tone dot decision signal 1 bit as the half-tone dot decision block data is converted to half-tone dot decision raster data through the line memory 2621 and output as half-tone dot decision data in synchronization with the image data.

Thus, the half-tone dot information data can be saved in the multi-value image data compression/reconstruction circuit 2500 and propagated to the image zoning processing circuit 2502 in the subsequent section.

Here, the method of processing a HAAR conversion by the multi-value image data compression/reconstruction circuit 2500, the method of processing de-quantization processing by a block half-tone dot decision and the method of processing inverse HAAR conversion will be explained.

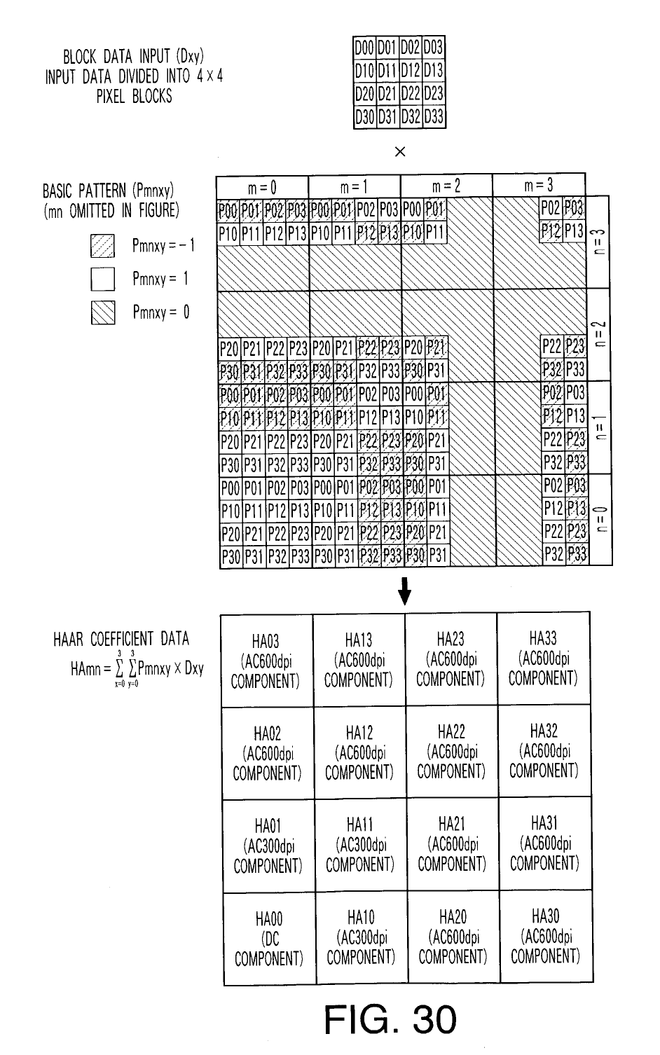

FIG. 30 shows the method of processing a HAAR conversion by the multi-value image data compression/reconstruction circuit 2500. The HAAR conversion is processing of converting the input block data (Dxy) to HAAR coefficient data (HAmn) and is calculated using the data value of a basic pattern (Pmnxy) in the same figure as follows.

$$HAmn = {\sum }_{x = 0}^{3} {\sum }_{y = 0}^{3} P m n x y \times Dxy$$

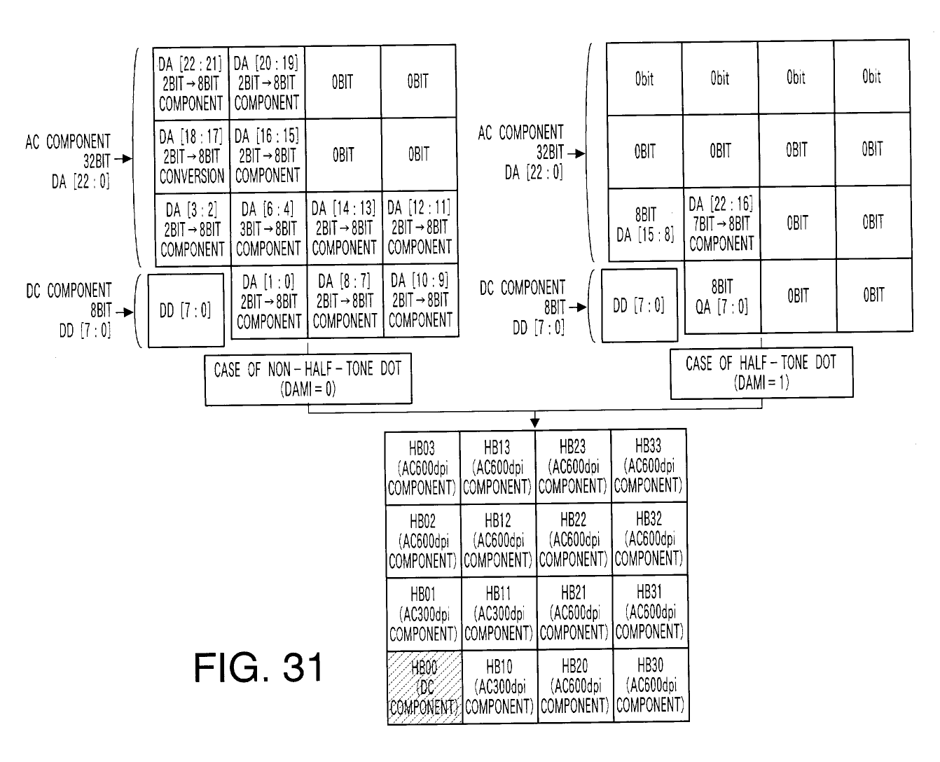

FIG. 31 shows the method of processing de-quantization processing using a block half-tone dot decision by the multi-value image data compression/reconstruction circuit 2500. The number of de-quantization bits and positions relative to the base are changed by the reconstructed half-tone dot decision signal (DAMI) and converted to a HAAR coefficient.

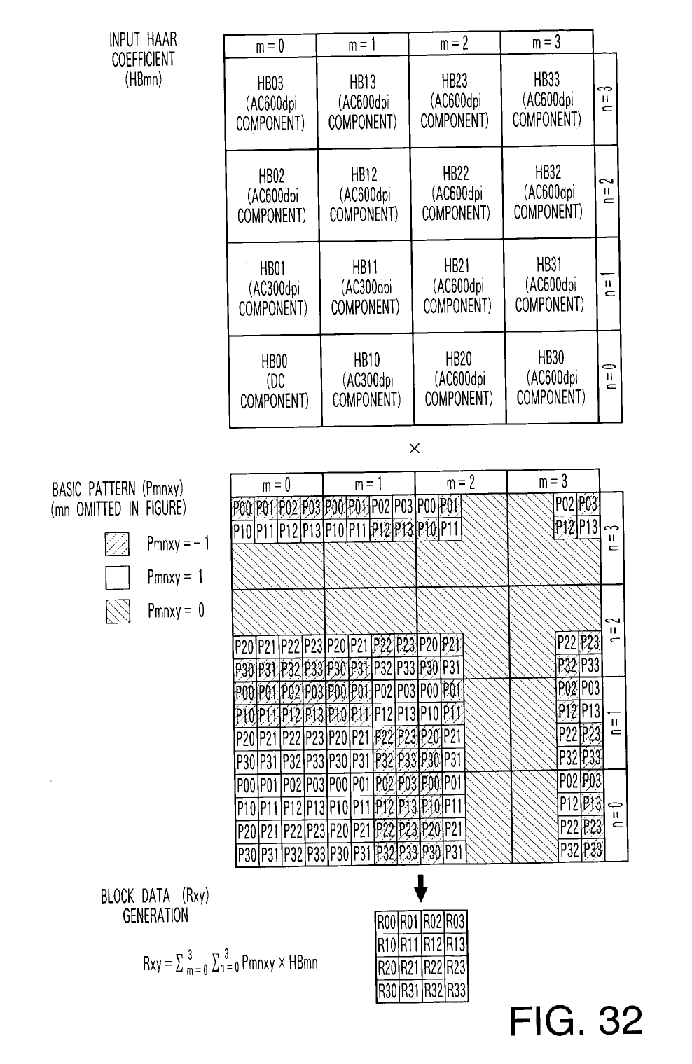

FIG. 32 shows the method of processing of inverse HAAR conversion by the multi-value image data compression/reconstruction circuit 2500. The inverse HAAR conversion is the processing of converting the input HAAR coefficient data (HAmn) to block data (Rxy) and is calculated using the basic pattern (Pmnxy) data values in the same figure as follows:

$$R x y = {\sum }_{m = 0}^{3} {\sum }_{n = 0}^{3} P m n x y \times HB mn$$

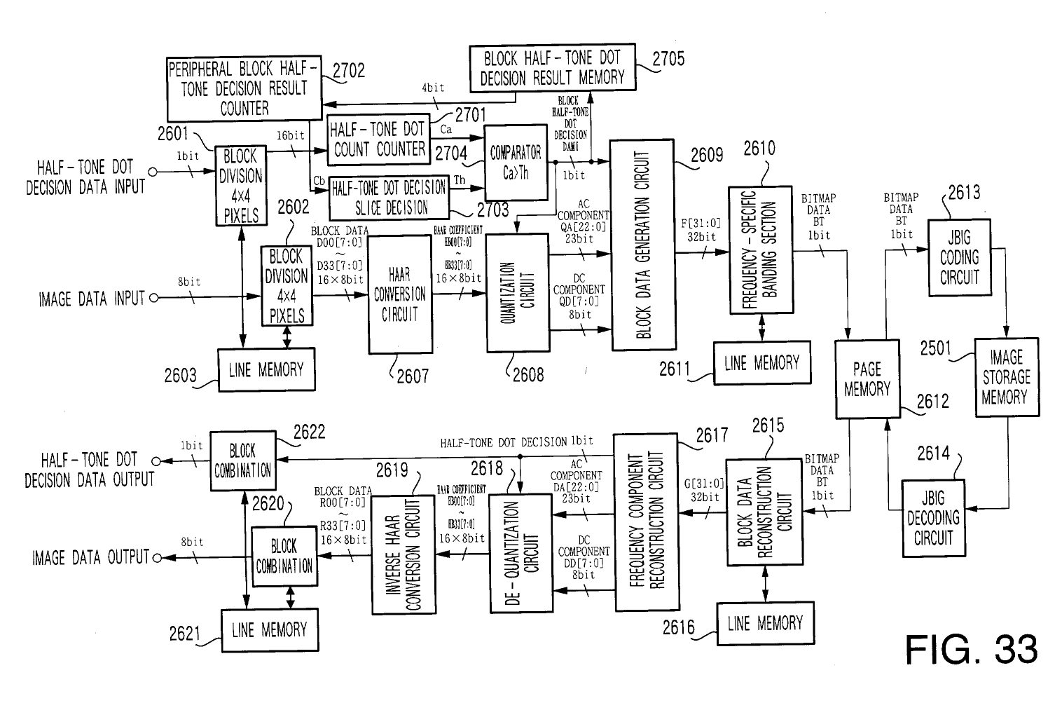

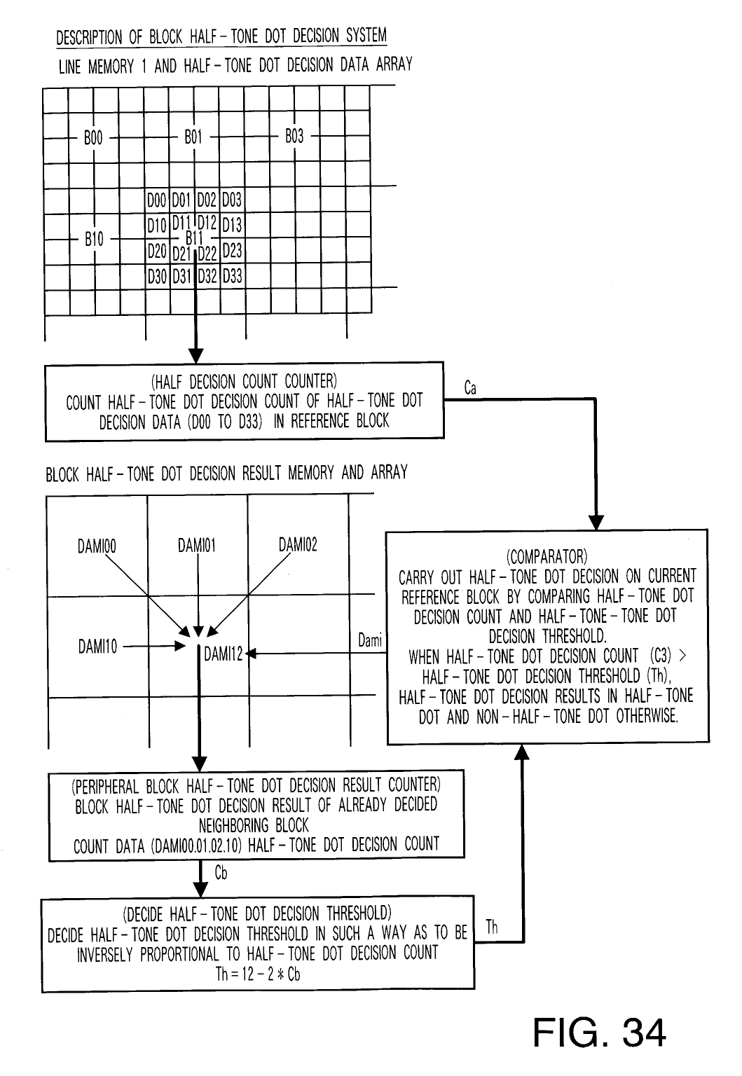

Then, a modification example of the above-described multi-value image data compression/reconstruction circuit will be explained. FIG. 33 is a block diagram of the multi-value image data compression/reconstruction circuit according to the modification example. The components having the same functions as those of the above-described multi-value image data compression/reconstruction circuit 2500 are assigned the same reference numerals. Furthermore, FIG. 34 shows a concept of the method for a block half-tone dot decision by the multi-value image data compression/reconstruction circuit.

This multi-value image data compression/reconstruction circuit counts the half-tone dot decision count in the same block from the half-tone dot decision data divided into 4×4 pixel blocks using a half-tone dot decision count counter 2701 to calculate a half-tone dot count (Ca).

On the other hand, with reference to the decision result of a block peripheral to the block currently being processed whose half-tone dot decision state has already been decided, the half-tone dot decision count is counted by a peripheral block half-tone dot decision result counter 2702. A half-tone dot decision slice decision circuit 2703 controls a slice (Th) in such a way as to be inversely proportional to the aforementioned count (Cd).

Then, the comparator 2704 compares the half-tone dot count (Ca) and slice (Th) and when the half-tone dot count is greater, the comparator 2704 decides that the block is a half-tone dot block and sets the block half-tone dot decision signal in a half-tone dot decision state and when the half-tone dot count is smaller, the comparator 2704 decides that the block is a non-half-tone dot block.

Furthermore, the block half-tone dot decision signal is written into a block half-tone dot decision result memory 2705 and used as reference data of the next block and subsequent peripheral blocks.

Thus, the slice used for a half-tone dot decision is dynamically controlled based on half-tone dot decision data of peripheral blocks, and therefore it is possible to improve the accuracy of generating a block half-tone dot decision signal of the multi-value image data compression/reconstruction circuit.

Then, a more specific configuration and operation of the character/photo/half-tone dot correspondence PWM control circuit 2504 will be explained.

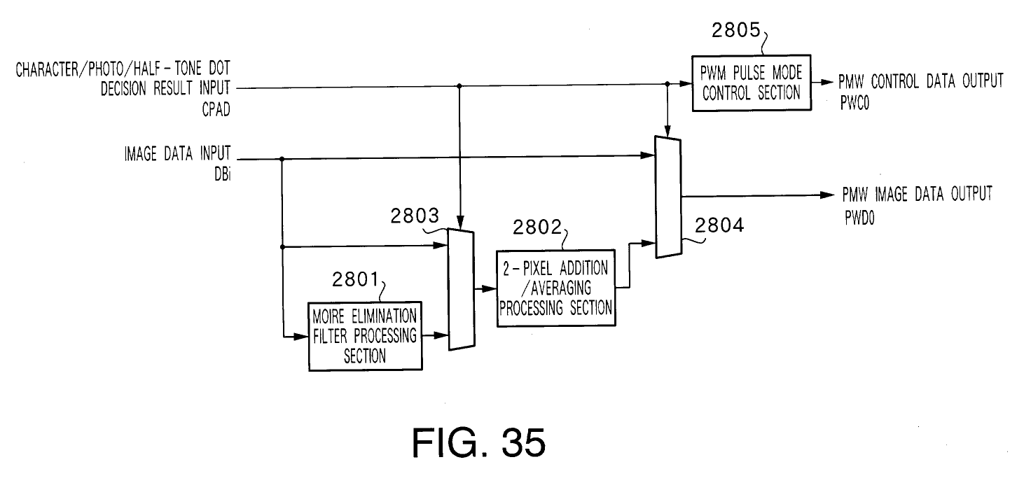

FIG. 35 shows a configuration of the character/photo/half-tone dot correspondence PWM control circuit 2504. It includes a moiré elimination filter processing section 2801 and a 2-pixel addition/averaging processing section 2802 and a selector 2803 switches between the output of image data (DBi) and the output of the moiré elimination filter processing section 2801 and another selector 2804 switches between the output of image data (DBi) and the output of the 2-pixel addition/averaging processing section 2802.

The character/photo/half-tone dot decision result (CPAD) executes the following image processing on the image data input from the image data input (DBi) and outputs PWM image data (PWDo).

When a character/photo/half-tone dot decision results in a character, the image data (DBi) is output with no processing applied.

Furthermore, when the character/photo/half-tone dot decision results in a photo, an addition/averaging value is calculated for each 2-pixel pair of even and odd pixels of the image data (DBi) and the values are output as data values of even and odd pixels.

Furthermore, when the character/photo/half-tone dot decision results in a half-tone dot, the image data (DBi) is subjected to moiré elimination filter processing, then an addition/averaging value is calculated for each 2-pixel pair of even and odd pixels and the value is output as the corresponding data value of even and odd pixels.

Furthermore, a PWM pulse mode control section 2805 controls PWM control data (PWCo) according to the character/photo/half-tone dot decision result (CPAD). More specifically, PWM control data (PWCo) is output as follows:

When the character/photo/half-tone dot decision results in a character, a control signal is generated so that PWM of 1-pixel cycle is generated.

Furthermore, when the character/photo/half-tone dot decision results in a photo or half-tone dot, a control signal is generated so that PWM of 2-pixel cycle is generated.

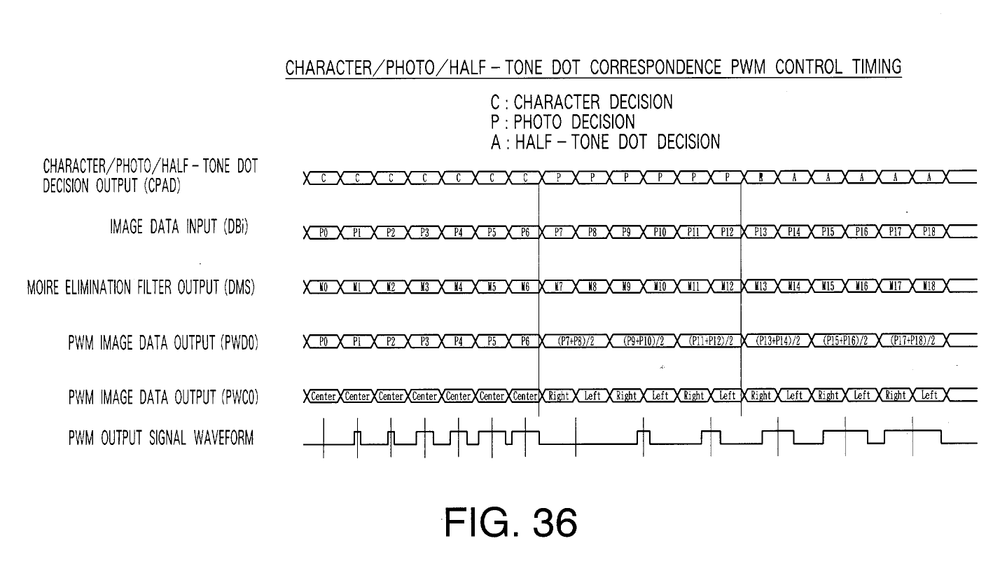

FIG. 36 shows a time chart of each signal of character/photo/half-tone dot correspondence PWM control and PWM output signal generated in the signal.

When a character/photo/half-tone dot decision input is a character, P1 to P6 signals of the image data input are directly output as the PWM image data output and when the character/photo/half-tone dot decision input is a photo, data obtained by adding/averaging P7 to P12 with a pair of odd and even pixels is output as the corresponding data. As a result, the odd pixel and even pixel have the same value.

Furthermore, when the character/photo/half-tone dot decision input is a half-tone dot, the image data input from the image data input is subjected to moiré elimination filter processing and data obtained by adding/averaging M13 to M18 of the resulting moiré elimination filter output data with a pair of odd and even pixels is output as the corresponding data. As a result, the odd and even pixels have the same value.

When the character/photo/half-tone dot decision input is a character, a CENTER mode is output as the PWM control data output.

In the CENTER mode, pulses of a PWM output signal grow uniformly from the center of 1-pixel cycle to both the right and left according to the image data value and the result is a PWM signal of 1-pixel cycle.

When the character/photo/half-tone dot decision input is anything other than a character, a RIGHT mode is output for odd pixels and a LEFT mode is output for even pixels.

In the RIGHT mode, pulses of a PWM output signal grow from the right to left of 1-pixel cycle according to the image data value. In the LEFT mode, pulses of a PWM output signal grow from the left to right of 1-pixel cycle and the result becomes a PWM output signal of 2-pixel cycle.

The character section becomes a PWM of 1-pixel cycle, and therefore it is possible to print an image with high resolution and high sharpness. On the other hand, because the non-character section becomes a PWM of 2-pixel cycle, influences of printing variations are reduced and an image of a high gradation characteristic can be printed.

The present invention is not limited to the above described embodiments, and various variations and modifications may be possible without departing from the scope of the present invention.

This application is based on the Japanese Patent Application No.2002-11527 filed on Jan. 21, 2002, entire content of which is expressly incorporated by reference herein.

What is claimed is:

1. An image signal processing apparatus comprising:
a data input section that inputs image data;
a half-tone dot decision information adding section that decides whether the image data input from said data input section is a half-tone dot image or not according to a plurality of pixel data making up a reference range in said image data, adds the half-tone dot decision result data to pixel data located in the center of said reference range and outputs said pixel data and said half-tone dot decision result data synchronously;
a scaling processing section that receives the pixel data and half-tone dot decision result data sequentially output from said half-tone dot decision information adding section, scales up or scales down the pixel data and half-tone dot decision result data and outputs the scaled-up or scaled-down image data and half-tone dot decision result data synchronously; and
an output section that outputs the image data and half-tone dot decision result data sequentially output from said scaling processing section to the outside.

2. The image signal processing apparatus according to claim 1, wherein said scaling processing section comprising:
a sub-scanning scale-down interpolation circuit that carries out interpolation on the image data scaled down in the sub-scanning direction;
a main scanning scale-down interpolation circuit that carries out interpolation processing on the image data scaled down in the main scanning direction;
a main scanning scale-up interpolation circuit that carries out interpolation processing on the image data scaled up in the main scanning direction;
a first and second line memories to which the input image data, the output data of said sub-scanning scale-down interpolation circuit and said main scanning scale-down interpolation circuit is written; and
a control section that decides whether output of the image data on the current line is enabled or disabled for each image data input line, whether output of the image data on the next line is enabled or disabled, decides the interpolation circuits to be enabled and order of processes according to the respective states obtained and controls the data path of the input image data, and
the pair of the image data and half-tone dot decision result data is configured to pass through the same data path decided by said control section.

3. The image signal processing apparatus according to claim 2, wherein said sub-scanning scale-down interpolation circuit and said main scanning scale-down interpolation circuit perform OR processing on the half-tone dot decision data within the same range as the interpolation range of the image data and generate the processing result as scaled-down half-tone dot decision data.

4. The image signal processing apparatus according to claim 2, wherein said sub-scanning scale-down interpolation circuit and said main scanning scale-down interpolation circuit perform OR processing on the half-tone dot decision data limited to two pixels at predetermined positions within the same range as the interpolation range of the image data and generate the processing result as scaled-down half-tone dot decision data.

5. The image signal processing apparatus according to claim 2, wherein said sub-scanning scale-down interpolation circuit and said main scanning scale-down interpolation circuit count a half-tone dot decision data count within the same range as the interpolation range of the image data and generate half-tone dot decision data scaled down according to the count value.

6. The image signal processing apparatus according to claim 2, further comprising a scaling control section that calculates an output pixel position for output pixel with reference to the position of an input pixel all the time, wherein said sub-scanning scale-down interpolation circuit, said main scanning scale-down interpolation circuit and said main scanning scale-up interpolation circuit select, based on information of said calculated output pixel position and half-tone dot decision data at the same position as that of the input pixel data at two points sandwiching said output pixel position, one of said two half-tone dot decision data pieces according to the size of the information of said calculated output pixel position.

7. The image signal processing apparatus according to claim 1, wherein interpolation processing on half-tone dot decision data is selected according to a selection of scaling interpolation processing of the image data.

8. An image signal processing apparatus comprising:
a data input section that inputs image data;
a half-tone dot decision information adding section that decides whether the image data input from said data input section from among a plurality of image data pieces making up a reference range in said image data is a half-tone dot image or not, adds the half-tone dot decision result data to image data located in the center of said reference range and outputs said image data and said half-tone dot decision result data synchronously;
a space filter processing section that receives the image data and half-tone dot decision result data sequentially output from said half-tone dot decision information adding section, applies space filter processing with reference to a predetermined range of the input image data, adjusts the image position of the image data subjected to the space filter processing in such a way as to match the image position of the input half-tone dot decision result data and outputs both data pieces synchronously; and
an output section that outputs the image data and half-tone dot decision result data sequentially output from said space filter processing section to the outside.

9. An image signal processing apparatus comprising:
a data input section that inputs image data;
a half-tone dot decision information adding section that decides whether the image data input from said data input section from among a plurality of image data pieces making up a reference range in said image data is a half-tone dot image or not, adds the half-tone dot decision result data to image data located in the center of said reference range and outputs said image data and said half-tone dot decision result data synchronously;
a first and second image processing sections that perform image processing using the synchronously input image data and half-tone dot decision result data, adjust the image position of the image data subjected to the image processing in such a way as to match the image position of the half-tone dot decision result data and output both data pieces synchronously;
a first data selection section that receives a second data pair of the image data and the half-tone dot decision result data output from said second image processing section as one input, receives a third data pair of the image data and the half-tone dot decision result data output from said half-tone dot decision information adding section as the other input and inputs one data pair selected from the two pairs to said first image processing section;
a second data selection section that receives a first data pair of the image data and the half-tone dot decision result data output from said first image processing section as one input, receives said third data pair as the other input and inputs one data pair selected from the two pairs to said second image processing section;
a third data selection section that receives said first data pair, said second data pair and said third data pair as inputs and selects any one of the three; and
an output section that outputs the image data and the half-tone dot decision result data selected from said third selection section to the outside.

10. An image signal processing apparatus comprising:
a data input section that inputs image data;
a half-tone dot decision information adding section that decides whether the image data input from said data input section from among a plurality of image data pieces making up a reference range in the image data is a half-tone dot image or not, adds the half-tone dot decision result data to image data located in the center of the reference range and outputs the image data and said half-tone dot decision result data synchronously;
a multi-value image data compression/reconstruction section that receives the image data and half-tone dot decision result data sequentially output from said half-tone dot decision information adding section, codes the image data and half-tone dot decision data into one piece of fixed length data and saves the data in an image storage memory, decodes the data saved in said image storage memory and outputs the image data and half-tone dot decision result data synchronously; and
an output section that outputs the image data and the half-tone dot decision result data sequentially output from said multi-value image data compression/reconstruction section to the outside.

11. The image signal processing apparatus according to claim 10, wherein switching between quantization processing used for coding said fixed length data and de-quantization processing used for decoding is carried out using the half-tone dot decision result data.

12. The image signal processing apparatus according to claim 10, further comprising:
a block half-tone dot decision section that divides the input half-tone dot decision data into blocks and decides whether each block is a half-tone dot area or non-half-tone dot area based on the count value of the half-tone dot count in the block; and
a block data generation section that adds information of the decision result by said block half-tone dot decision section to the fixed-length coded image data.

13. The image signal processing apparatus according to claim 10, further comprising:
a block half-tone dot decision result memory into which the block half-tone dot decision result is written; and
a block half-tone dot decision section that counts a half-tone dot decision count of a peripheral block according to the block half-tone dot decision result read from said block half-tone dot decision result memory and decides whether the block is a non-half-tone dot area or not.

14. The image signal processing apparatus according to claim 10, wherein said multi-value image data compression/reconstruction section comprising:
a bit placing section that places bits of the half-tone dot decision data near the DC component or AC low frequency component of the image data when the image data and half-tone dot decision data are coded into one fixed-length data and saved in the image storage memory;
a variable-length coder that compresses fixed-length data in said image storage memory to variable-length data; and
a variable-length decoder that decodes said variable-length data to said fixed-length data.

15. An image signal processing apparatus comprising:
a data input section that inputs image data;
a half-tone dot decision information adding section that decides whether the image data input from said data input section from among a plurality of image data pieces making up a reference range in said image data is a half-tone dot image or not, adds the half-tone dot decision result data to image data located in the center of said reference range and outputs said image data and said half-tone dot decision result data synchronously; and
an image zoning decision section that receives the image data and half-tone dot decision result data sequentially output from said half-tone dot decision information adding section and decides whether the data is a character, photo or half-tone dot image based on the half-tone dot decision result data and image data.

16. The image signal processing apparatus according to claim 15, wherein said image zoning decision section comprising:
a character/photo decision section that decides whether the data is a character or photo from the input image data; and
an overall decision section that decides whether the data is a character, photo or half-tone dot image from said character/photo decision result and the half-tone dot decision result data input in synchronization with said image data.

17. An image signal processing apparatus comprising:
a data input section that inputs image data;
a half-tone dot decision information adding section that decides whether the image data input from said data input section from among a plurality of image data pieces making up a reference range in said image data is a half-tone dot image or not, adds the half-tone dot decision result data to image data located in the center of said reference range and outputs said image data and said half-tone dot decision result data synchronously;
an image zoning decision section that receives the image data and half-tone dot decision result data sequentially output from said half-tone dot decision information adding section and decides whether the data is a character, photo or half-tone dot image based on the half-tone dot decision result data and image data;
an adaptive half-tone processing section that selects half-tone processing from said image zoning decision result; and
an output section that outputs the image data subjected to said half-tone processing to the outside.

18. An image signal processing apparatus comprising:
a data input section that inputs image data;
a half-tone dot decision information adding section that decides whether the image data input from said data input section from among a plurality of image data pieces making up a reference range in the image data is a half-tone dot image or not, adds the half-tone dot decision result data to image data located in the center of the reference range and outputs the image data and said half-tone dot decision result data synchronously;
an image zoning decision section that receives the image data and half-tone dot decision result data sequentially output from said half-tone dot decision information adding section as inputs and decides whether the data is a character, photo or half-tone dot image based on the half-tone dot decision result data and image data;
a character/photo/half-tone dot correspondence PWM control section that switches between PWM cyclic control and PWM data based on said image zoning decision result; and
an output section that outputs the control signal and the image data subjected to said PWM control.

19. The image signal processing apparatus according to claim 18, wherein when the decision result from said image zoning decision section shows that the data is a half-tone dot, the PWM data is subjected to moiré elimination filter processing.
